(19) United States
(12) Patent Application Publication
(10) Pub. No.: US 2022/0103846 A1
(43) Pub. Date: Mar. 31, 2022

(54) SUPPLEMENTAL ENHANCEMENT INFORMATION MESSAGE IN VIDEO CODING

(71) Applicant: ALIBABA GROUP HOLDING LIMITED, George Town (KY)

(72) Inventors: Jie CHEN, San Mateo, CA (US); Yan YE, San Mateo, CA (US); Jixiang HU, San Mateo, CA (US); Kun LI, San Mateo, CA (US); Lulu HU, San Mateo, CA (US); Yimin LONG, San Mateo, CA (US)

(21) Appl. No.: 17/444,699

(22) Filed: Aug. 9, 2021

Related U.S. Application Data
(60) Provisional application No. 63/084,116, filed on Sep. 28, 2020.

(51) Int. Cl. H04N 19/46; H04N 19/20; H04N 19/105; H04N 19/17

(52) U.S. Cl. CPC H04N 19/46; H04N 19/17; H04N 19/105; H04N 19/20

(57) ABSTRACT

The present disclosure provides methods, apparatus and non-transitory computer readable medium for processing video data. According to certain disclosed embodiments, a method for determining an object in a picture includes: decoding a message from a bitstream including: decoding a first list of labels; and decoding a first index, to the first list of labels, of a first label associated with the object; and determining the object based on the message.

### CROSS-REFERENCE TO RELATED APPLICATIONS

The disclosure claims the benefits of priority to U.S. Provisional Application No. 63/084,116, filed on Sep. 28, 2020, which is incorporated herein by reference in its entirety.

### TECHNICAL FIELD

The present disclosure generally relates to video processing, and more particularly, to supplemental enhancement information (SEI) message in video coding.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a method for determining an object in a picture. The method includes: decoding a message from a bitstream including: decoding a first list of labels; and decoding a first index, to the first list of labels, of a first label associated with the object; and determining the object based on the message.

Embodiments of the present disclosure provide an apparatus for performing video data processing, the apparatus including: a memory figured to store instructions; and one or more processors configured to execute the instructions to cause the apparatus to perform: decoding a message from a bitstream including: decoding a first list of labels; and decoding a first index, to the first list of labels, of a first label associated with the object; and determining the object based on the message.

Embodiments of the present disclosure provide a non-transitory computer-readable storage medium that stores a set of instructions that is executable by one or more processors of an apparatus to cause the apparatus to initiate a method for determining an object in a picture, the method includes: decoding a message from a bitstream including: decoding a first list of labels; and decoding a first index, to the first list of labels, of a first label associated with the object; and determining the object based on the message.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an example video sequence, according to some embodiments of the present disclosure.

FIG. 2A is a schematic diagram illustrating an exemplary encoding process of a hybrid video coding system, consistent with embodiments of the present disclosure.

FIG. 2B is a schematic diagram illustrating another exemplary encoding process of a hybrid video coding system, consistent with embodiments of the present disclosure.

FIG. 3A is a schematic diagram illustrating an exemplary decoding process of a hybrid video coding system, consistent with embodiments of the present disclosure.

FIG. 3B is a schematic diagram illustrating another exemplary decoding process of a hybrid video coding system, consistent with embodiments of the present disclosure.

FIG. 4 is a block diagram of an exemplary apparatus for encoding or decoding a video, according to some embodiments of the present disclosure.

FIG. 5 shows an exemplary syntax of AR SEI message in the current HEVC.

FIG. 6 illustrates a flowchart of an exemplary method for video processing using object representation SEI message, according to some embodiments of the present disclosure.

FIG. 7A shows an exemplary syntax of the object representation SEI message, according to some embodiments of the present disclosure.

FIG. 7B shows an exemplary pseudocode including derivation for array ArBoundingPolygonVertexX [or_object_idx[i]][j] and ArBoundingPolygonVertexY [or_object_idx[i]][j], according to some embodiments of the present disclosure.

FIG. 8A illustrates a flowchart of an exemplary method for video processing using object representation SEI message, according to some embodiments of the present disclosure.

FIG. 8B shows an exemplary portion of syntax structure of adding signaling condition for object information, according to some embodiments of the present disclosure.

FIG. 9A illustrates an exemplary portion of syntax structure for signaling object position parameters and object label information, according to some embodiments of the present disclosure.

FIG. 9B illustrates another exemplary portion of syntax structure for signaling object position parameters and object label information, according to some embodiments of the present disclosure.

FIG. 10A illustrates a flowchart of an exemplary method for dependent secondary label lists, according to some embodiments of the present disclosure.

FIG. 10B shows an exemplary portion of syntax structure of dependent secondary label lists, according to some embodiments of the present disclosure.

FIG. 11A illustrates a flowchart of an exemplary method for video processing using combined label list, according to some embodiments of the present disclosure.

FIG. 11B shows an exemplary portion of syntax structure of combined label list, according to some embodiments of the present disclosure.

FIG. 11C shows another exemplary portion of syntax structure of combined label list, according to some embodiments of the present disclosure.

FIG. 12 illustrates a flowchart of an exemplary method for video processing using object representation SEI message, according to some embodiments of the present disclosure.

FIG. 13 shows an exemplary portion of syntax structure of applying same bounding method for all objects, according to some embodiments of the present disclosure.

FIG. 14A shows an exemplary portion of syntax structure of signaling different value of coordinates of two connected vertex, according to some embodiments of the present disclosure.

FIG. 14B shows an exemplary pseudocode including derivation for array ArBoundingPolygonVertexX [or_object_idx[i]][j] and ArBoundingPolygonVertexY [or_object_idx[i]][j], according to some embodiments of the present disclosure.

FIG. 15 shows an exemplary portion of syntax structure of only using bounding polygon, according to some embodiments of the present disclosure.

FIG. 16A shows an exemplary portion of syntax structure of using a fixed length code, according to some embodiments of the present disclosure.

FIG. 16B shows an exemplary portion of syntax structure of using a variable length code, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recent, and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

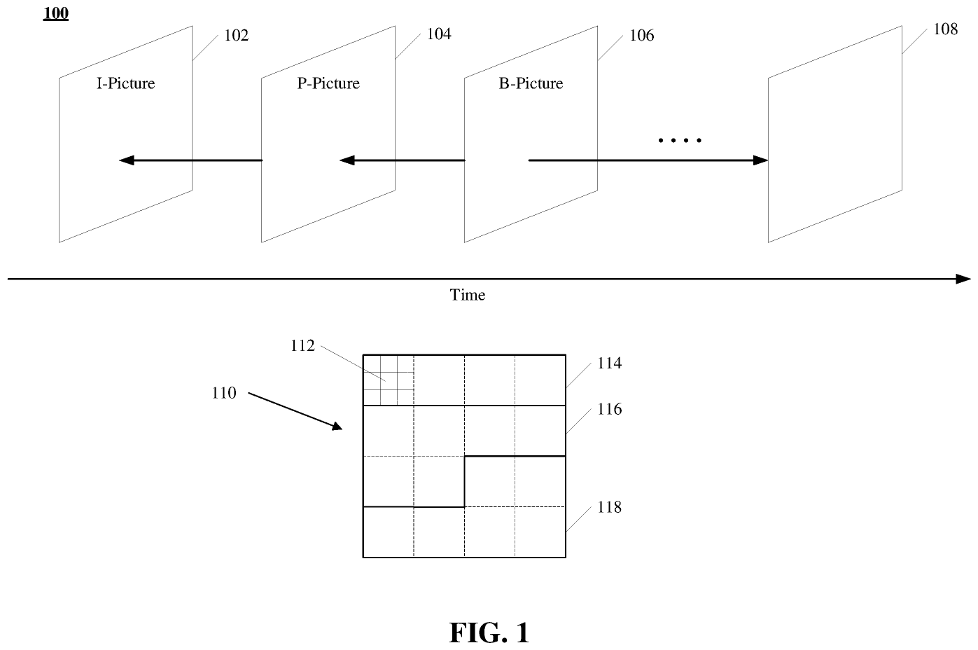

FIG. 1 illustrates structures of an example video sequence 100, according to some embodiments of the present disclosure. Video sequence 100 can be a live video or a video having been captured and archived. Video 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

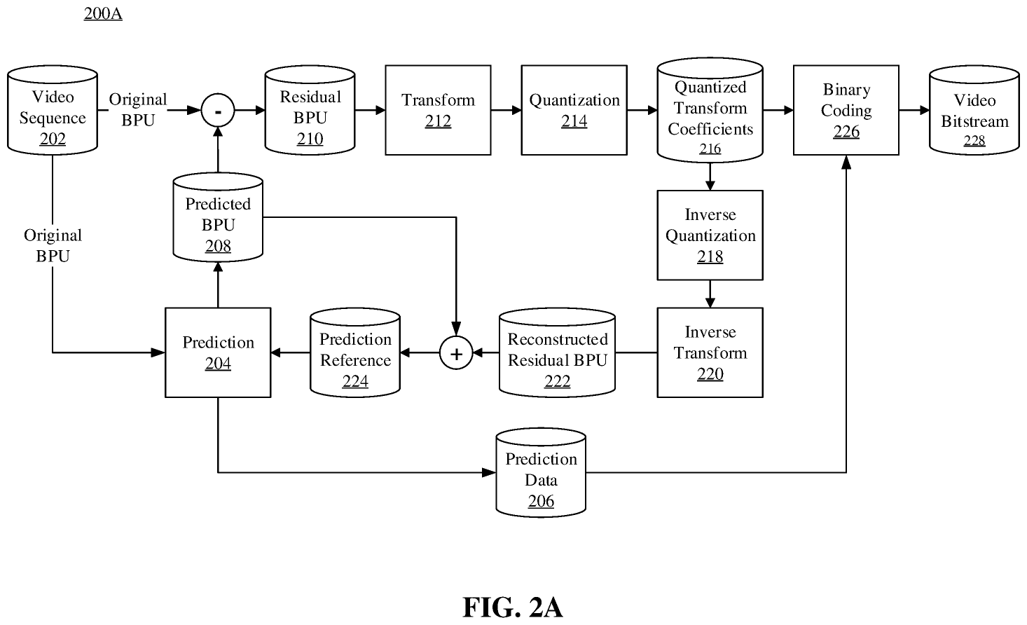

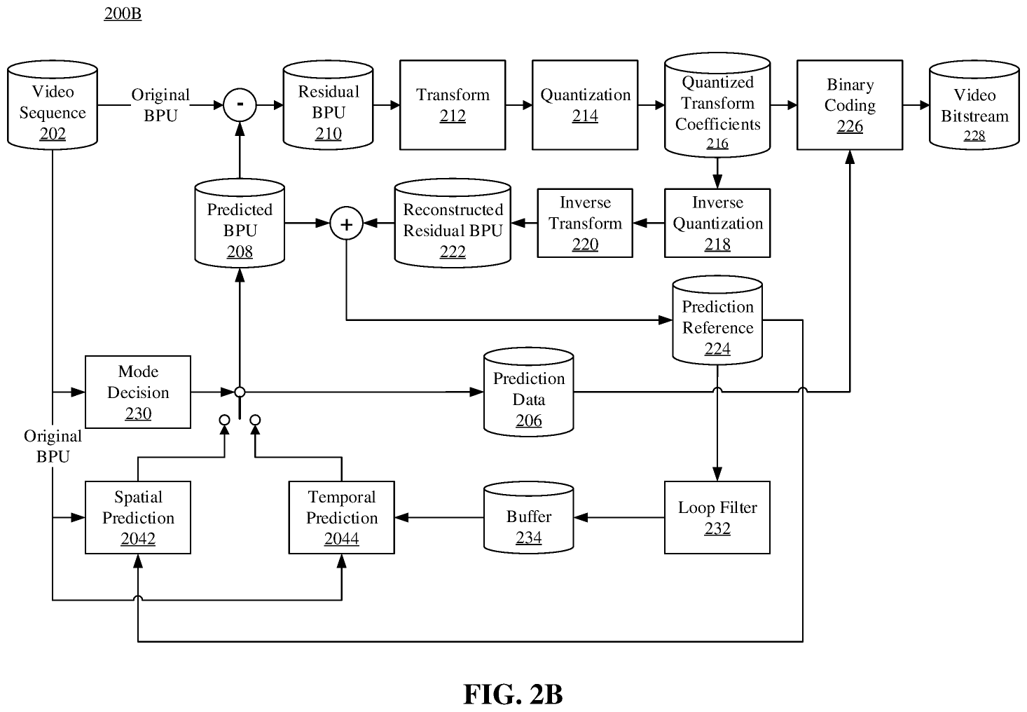

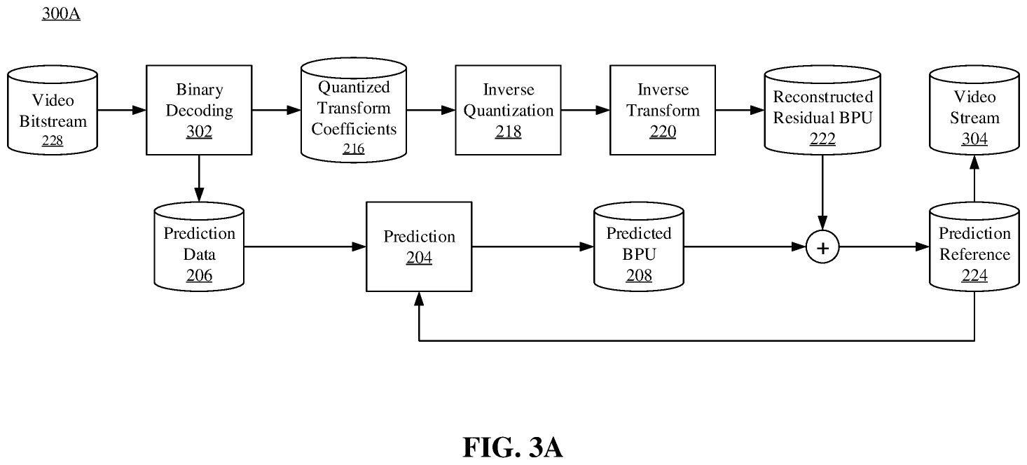

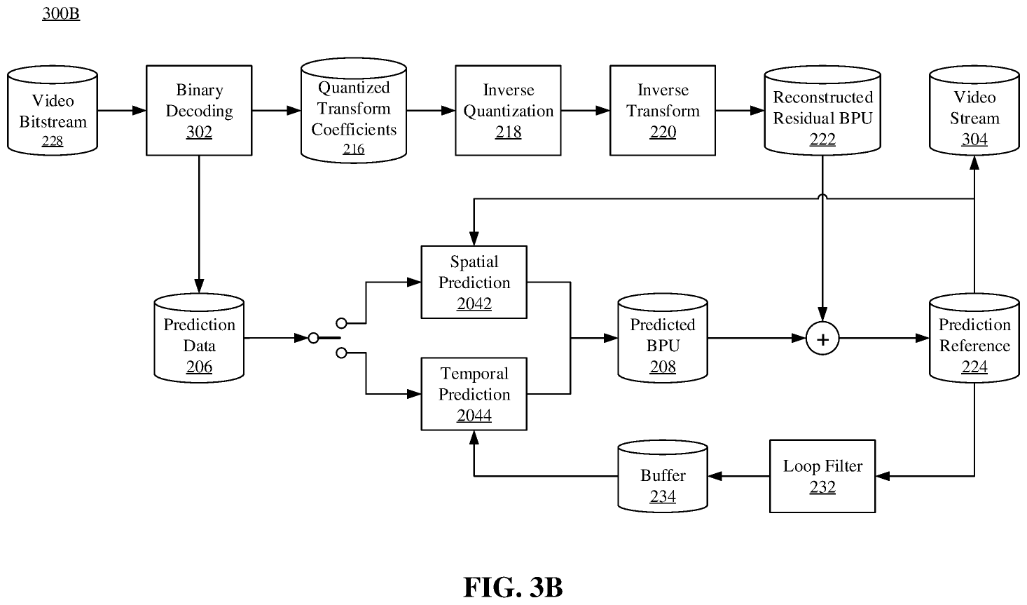

Video coding has multiple stages of operations, examples of which are shown in FIGS. 2A and 2B and FIGS. 3A and 3B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC), and decide a prediction type for each individual basic processing sub-unit.

For another example, at a prediction stage (an example of which is shown in FIGS. 2A and 2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIGS. 2A-2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an example encoding process 200A, consistent with embodiments of the present disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224, and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization parameter or any other parameter of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, parameters of the prediction operation, a transform type at transform stage 212, parameters of the quantization process (e.g., quantization parameters), an encoder control parameter (e.g., a bitrate control parameter), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another example encoding process 200B, consistent with embodiments of the present disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer”) for later use (e.g., to be used as an inter-prediction reference picture for a future picture of video sequence 202). The encoder can store one or more reference pictures in buffer 234 to be used at temporal prediction stage 2044. In some embodiments, the encoder can encode parameters of the loop filter (e.g., a loop filter strength) at binary coding stage 226, along with quantized transform coefficients 216, prediction data 206, and other information.

FIG. 3A illustrates a schematic diagram of an example decoding process 300A, consistent with embodiments of the present disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIGS. 2A and 2B), generally, video stream 304 is not identical to video sequence 202. Similar to processes 200A and 200B in FIGS. 2A and 2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, the decoder can depacketize video bitstream 228 before feeding it to binary decoding stage 302.

FIG. 3B illustrates a schematic diagram of another example decoding process 300B, consistent with embodiments of the present disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include parameters of the loop filter (e.g., a loop filter strength). In some embodiments, prediction data includes parameters of the loop filter when the prediction mode indicator of prediction data 206 indicates that inter prediction was used to encode the current BPU.

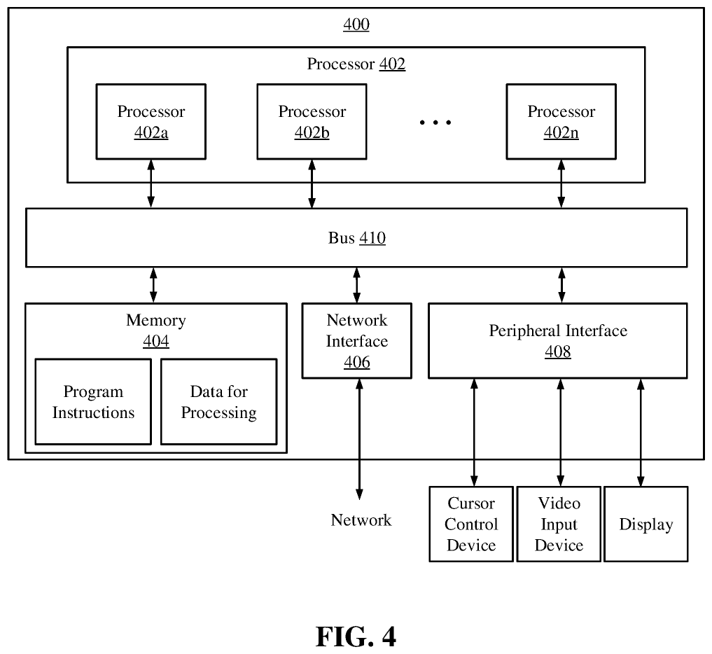

FIG. 4 is a block diagram of an example apparatus 400 for encoding or decoding a video, consistent with embodiments of the present disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

The present disclosure provides methods used in the above-described encoder (e.g., by process 200A of FIG. 2A or 200B of FIG. 2B) and decoder (e.g., by process 300A of FIG. 3A or 300B of FIG. 3B) for Supplemental Enhancement Information (SEI) messages. SEI messages are intended to be conveyed within coded video bitstream in a manner specified in a video coding specification or to be conveyed by other means determined by the specifications for systems that make use of such coded video bitstream. SEI messages can contain various types of data that indicate the timing of the video pictures or describe various properties of the coded video or how it can be used or enhanced. SEI messages can also contain arbitrary user-defined data. SEI messages do not affect the core decoding process, but can indicate how the video is recommended to be post-processed or displayed.

To specify SEI message, H.274/VSEI standard is developed, which specifies the syntax and semantics of video usability information (VUI) parameters and supplemental enhancement information (SEI) messages that are particularly intended for use with coded video bitstreams as specified by VVC standard. But since VUI parameters and SEI message do not affect the decoding process, the SEI messages in H.274/VSEI can also be used with other types of coded video bitstream, such as H.265/HEVC, H.264/AVC, etc.

For the purpose of object detection and tracking, the current H.265/HEVC standard adopted annotated regions (AR) SEI message which carries parameters to describe the bounding box of detected or tracked objects within the compressed video bitstream, so that the decoder-side device needn't perform video analysis to recognize the object if an encoder, a transcoder, or a network node has already recognized the object. This is beneficial to applications where the decoder device has limited computation resource and/or limited power supplies. Meanwhile, performing object detecting and tracking at encoder side and transmitting the information to the decoder can help improve the accuracy of the detection and tracking since encoder can perform the detection and tracking task using the original video which could be with much higher quality than the reconstructed video recovered in the decoder side.

In the AR SEI message in H.265/HEVC, besides the bounding box of the detected or tracked object, object labels and confidence levels associated with the objects may also be provided. The object label provides the information about the object, and the confidence level shows the fidelity of the detected or tracked object in the bounding box. Additionally, a flag indicating if bounding boxes in the current SEI message represent the position of objects which may be occluded or partially occluded by other objects or only represent the position of the visible part of the object is provided. And a flag indicating if the object represented by the current bounding box is only partially visible can be optionally signaled for each bounding box as well.

The syntax of AR SEI message uses persistence of parameters to avoid the need to re-signal information already available in previous SEI message within the same persistence scope. For example, if a first detected object stays stationary in the current picture relative to previous coded pictures and a second detected object moves from one picture to another, then only bounding box information for the second object needs to be signaled, and the location/bounding box information of the first object can be copied from previous SEI messages.

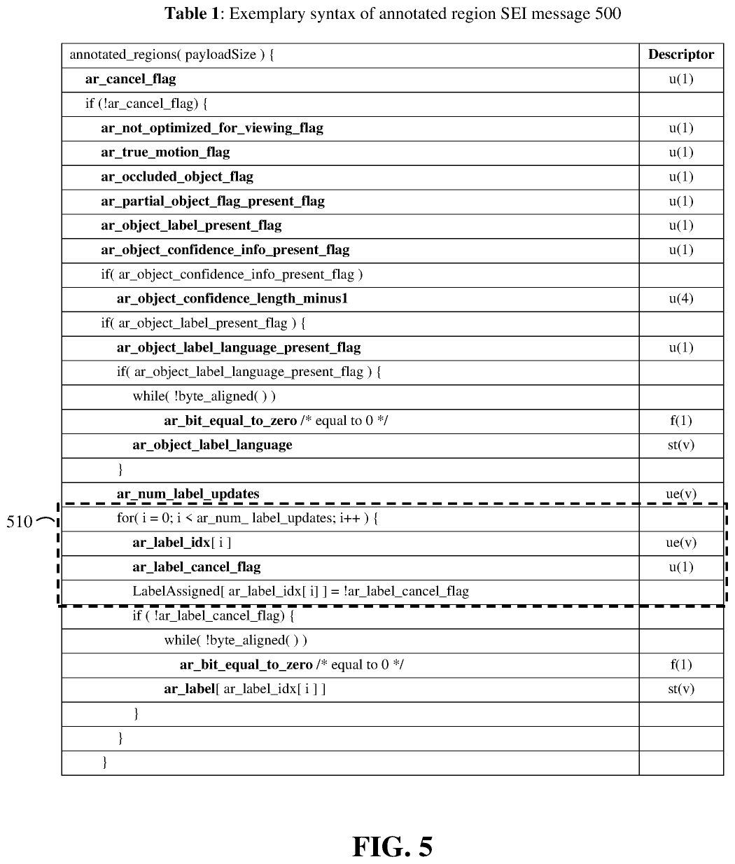

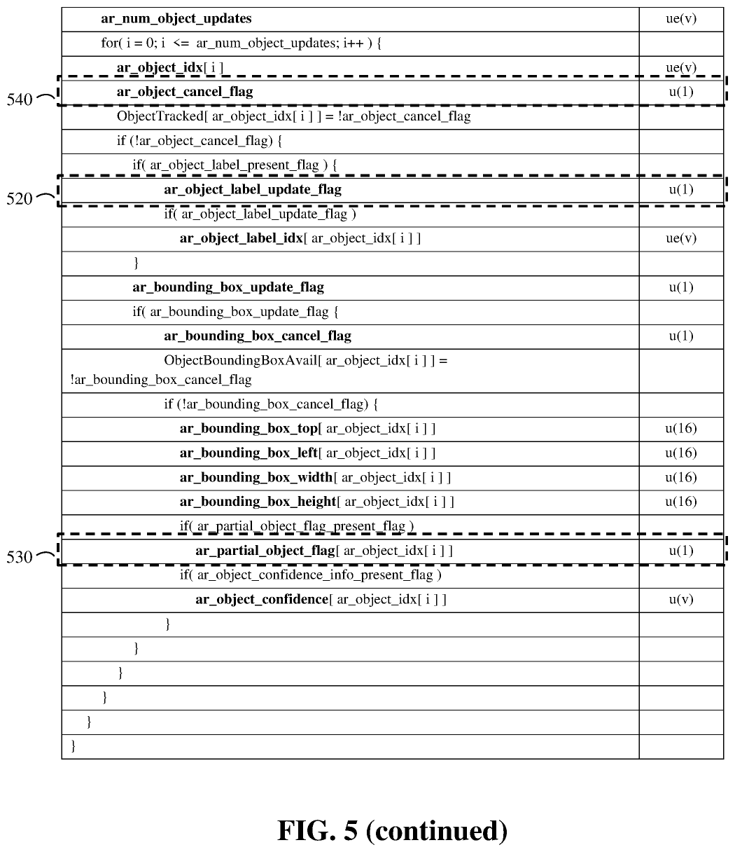

FIG. 5 shows an exemplary syntax 500 of annotated regions (AR) SEI message in the current HEVC. The annotated regions (AR) SEI message carries parameters that identify annotated regions using bounding boxes representing the size and location of identified objects. The semantics of the syntax elements are given below.

Syntax element ar_cancel_flag being equal to 1 indicates that the annotated regions SEI message cancels the persistence of any previous annotated regions SEI message that is associated with one or more layers to which the annotated regions SEI message applies. Syntax element ar_cancel_flag being equal to 0 indicates that annotated regions information follows.

When syntax element ar_cancel_flag equals to 1 or a new coded layer video sequence (CLVS) of the current layer begins, the variables LabelAssigned[i], ObjectTracked[i], and ObjectBoundingBoxAvail are set equal to 0 for i in the range of 0 to 255, inclusive.

Let picA be the current picture. Each region identified in the annotated regions SEI message persists for the current layer in output order until any of the following conditions are true: (i) a new CLVS of the current layer begins; (ii) the bitstream ends; or (iii) a picture picB in the current layer in an access unit containing an annotated regions SEI message that is applicable to the current layer is output for which PicOrderCnt (picB) is greater than PicOrderCnt (picA), where PicOrderCnt (picB) and PicOrderCnt (picA) are the PicOrderCntVal values of picB and picA, and the semantics of the annotated regions SEI message for PicB cancels the persistence of the region identified in the annotated regions SEI message for PicA.

Syntax element ar_not_optimized_for_viewing_flag being equal to 1 indicates that the decoded pictures that the annotated regions SEI message applies to are not optimized for user viewing, but rather are optimized for some other purpose such as algorithmic object classification performance. Syntax element ar_not_optimized_for_viewing_flag being equal to 0 indicates that the decoded pictures that the annotated regions SEI message applies to may or may not be optimized for user viewing.

Syntax element ar_true_motion_flag being equal to 1 indicates that the motion information in the coded pictures that the annotated regions SEI message applies to was selected with a goal of accurately representing object motion for objects in the annotated regions. Syntax element ar_true_motion_flag being equal to 0 indicates that the motion information in the coded pictures that the annotated regions SEI message applies to may or may not be selected with a goal of accurately representing object motion for objects in the annotated regions.

Syntax element ar_occluded_object_flag being equal to 1 indicates that the syntax elements ar_bounding_box_top[ar_object_idx[i]], ar_bounding_box_left[ar_object_idx[i]], ar_bounding_box_width[ar_object_idx[i]], and ar_bounding_box_height[ar_object_idx[i]] each of which represents the size and location of an object or a portion of an object that may not be visible or may be only partially visible within the cropped decoded picture. Syntax element ar_occluded_object_flag being equal to 0 indicates that the syntax elements ar_bounding_box_top[ar_object_idx[i]], ar_bounding_box_left[ar_object_idx[i]], ar_bounding_box_width[ar_object_idx[i]], and ar_bounding_box_height[ar_object_idx[i]] represent the size and location of an object that is entirely visible within the cropped decoded picture. It is a requirement of bitstream conformance that the value of ar_occluded_object_flag is the same for all annotated_regions( ) syntax structures within a CLVS.

Syntax element ar_partial_object_flag_present_flag being equal to 1 indicates that ar_partial_object_flag[ar_object_idx[i]] syntax elements are present. Syntax element ar_partial_object_flag_present_flag being equal to 0 indicates that ar_partial_object_flag[ar_object_idx[i]] syntax elements are not present. It is a requirement of bitstream conformance that the value of ar_partial_object_flag_present_flag is the same for all annotated_regions( ) syntax structures within a CLVS.

Syntax element ar_object_label_present_flag being equal to 1 indicates that label information corresponding to objects in the annotated regions is present. Syntax element ar_object_label_present_flag being equal to 0 indicates that label information corresponding to the objects in the annotated regions is not present.

Syntax element ar_object_confidence_info_present_flag being equal to 1 indicates that ar_object_confidence[ar_object_idx[i]] syntax elements are present. Syntax element ar_object_confidence_info_present_flag being equal to 0 indicates that ar_object_confidence[ar_object_idx[i]] syntax elements are not present. It is a requirement of bitstream conformance that the value of ar_object_confidence_present_flag is the same for all annotated_regions( ) syntax structures within a CLVS.

Syntax element ar_object_confidence_length_minus1+1 specifies the length, in bits, of the ar_object_confidence[ar_object_idx[i]] syntax elements. It is a requirement of bitstream conformance that the value of ar_object_confidence_length_minus1 is the same for all annotated_regions( ) syntax structures within a CLVS.

Syntax element ar_object_label_language_present_flag being equal to 1 indicates that the syntax element ar_object_label_language is present. Syntax element ar_object_label_language_present_flag being equal to 0 indicates that the syntax element ar_object_label_language is not present.

Syntax element ar_bit_equal_to_zero is equal to zero.

Syntax element ar_object_label_language contains a language tag as specified by IETF (Internet Engineering Task Force) RFC (Requests for Comments) 5646 followed by a null termination byte equal to 0x00. The length of the syntax element ar_object_label_language is less than or equal to 255 bytes, not including the null termination byte. When not present, the language of the label is unspecified.

Syntax element ar_num_label_updates indicates the total number of labels associated with the annotated regions that is signaled. The value of ar_num_label_updates is in the range of 0 to 255, inclusive.

Syntax element ar_label_idx[i] indicates the index of the signaled label. The value of ar_label_idx[i] is in the range of 0 to 255, inclusive.

Syntax element ar_label_cancel_flag being equal to 1 cancels the persistence scope of the ar_label_idx[i]-th label. Syntax element ar_label_cancel_flag being equal to 0 indicates that the ar_label_idx[i]-th label is assigned a signaled value.

Syntax element ar_label[ar_label_idx[i]] specifies the contents of the ar_label_idx[i]-th label. The length of the ar_label[ar_label_idx[i]] syntax element is less than or equal to 255 bytes, not including the null termination byte.

Syntax element ar_num_object_updates indicates the number of object updates to be signaled. Syntax element ar_num_object_updates is in the range of 0 to 255, inclusive.

Syntax element ar_object_idx[i] is the index of the object parameters to be signaled. Syntax element ar_object_idx[i] is in the range of 0 to 255, inclusive.

Syntax element ar_object_cancel_flag being equal to 1 cancels the persistence scope of the ar_object_idx[i]-th object. Syntax element ar_object_cancel_flag being equal to 0 indicates that parameters associated with the ar_object_idx[i]-th object tracked object are signaled.

Syntax element ar_object_label_update flag being equal to 1 indicates that an object label is signaled. Syntax element ar_object_label_update flag being equal to 0 indicates that an object label is not signaled.

Syntax element ar_object_label_idx[ar_object_idx[i]] indicates the index of the label corresponding to the ar_object_idx[i]-th object. When syntax element ar_object_label_idx[ar_object_idx[i]] is not present, the value of syntax element ar_object_label_idx[ar_object_idx[i]] is inferred from a previous annotated regions SEI messages in output order in the same CLVS, if any.

Syntax element ar_bounding_box_update_flag being equal to 1 indicates that object bounding box parameters are signaled. Syntax element ar_bounding_box_update_flag being equal to 0 indicates that object bounding box parameters are not signaled.

Syntax element ar_bounding_box_cancel_flag being equal to 1 cancels the persistence scope of the ar_bounding_box_top[ar_object_idx[i]], ar_bounding_box_left[ar_object_idx[i]], ar_bounding_box_width[ar_object_idx[i]], ar_bounding_box_height[ar_object_idx[i]]. ar_partial_object_flag[ar_object_idx[i]], and ar_object_confidence[ar_object_idx[i]]. Syntax element ar_bounding_box_cancel_flag being equal to 0 indicates that ar_bounding_box_top[ar_object_idx[i]], ar_bounding_box_left[ar_object_idx[i]], ar_bounding_box_width[ar_object_idx[i]] ar_bounding_box_height[ar_object_idx[i]] ar_partial_object_flag[ar_object_idx[i]], and ar_object_confidence[ar_object_idx[i]] syntax elements are signaled.

Syntax elements ar_bounding_box_top[ar_object_idx[i]], ar_bounding_box_left[ar_object_idx[i]], ar_bounding_box_width[ar_object_idx[i]], and ar_bounding_box_height[ar_object_idx[i]] specify the coordinates of the top-left corner and the width and height, respectively, of the bounding box of the ar_object_idx[i]-th object in the cropped decoded picture, relative to the conformance cropping window specified by the active SPS.

The value of ar_bounding_box_left[ar_object_idx[i]] is in the range of 0 to croppedWidth/SubWidthC-1, inclusive.

The value of ar_bounding_box_top[ar_object_idx[i]] is in the range of 0 to croppedHeight/SubHeightC-1, inclusive.

The value of ar_bounding_box_width[ar_object_idx[i]] is in the range of 0 to croppedWidth/SubWidthtC-ar_bounding_box_left[ar_object_idx[i]], inclusive.

The value of ar_bounding_box_height[ar_object_idx[i]] is in the range of 0 to croppedHeight/SubHeightC-ar_bounding_box_top[ar_object_idx[i]], inclusive.

The identified object rectangle contains the luma samples with horizontal picture coordinates from SubWidthC*(conf_win_left_offset+ar_bounding_box_left[ar_object_idx[i]]) to SubWidthC*(conf_win_left_offset+ar_bounding_box_left[ar_object_idx[i]]+ar_bounding_box_width[ar_object_idx[i]])−1, inclusive, and vertical picture coordinates from SubHeightC*(conf_win_top_offset+ar_bounding_box_top[ar_object_idx[i]]) to SubHeightC*(conf_win_top_offset+ar_bounding_box_top[ar_object_idx[i]]+ar_bounding_box_height[ar_object_idx[i]])−1, inclusive.

The values of ar_bounding_box_top[ar_object_idx[i]], ar_bounding_box_left[ar_object_idx[i]], ar_bounding_box_width[ar_object_idx[i]] and ar_bounding_box_height[ar_object_idx[i]] persist in output order within the CLVS for each value of ar_object_idx[i]. When not present, the values of ar_bounding_box_top[ar_object_idx[i]], ar_bounding_box_left[ar_object_idx[i]], ar_bounding_box_width[ar_object_idx[i]] or ar_bounding_box_height[ar_object_idx[i]] are inferred from a previous annotated regions SEI message in output order in the CLVS, if any.

Syntax element ar_partial_object_flag[ar_object_idx[i]] being equal to 1 indicates that the ar_bounding_box_top[ar_object_idx[i]], ar_bounding_box_left[ar_object_idx[i]], ar_bounding_box_width[ar_object_idx[i]] and ar_bounding_box_height[ar_object_idx[i]] syntax elements represent the size and location of an object that is only partially visible within the cropped decoded picture. Syntax element ar_partial_object_flag[ar_object_idx[i]] being equal to 0 indicates that the ar_bounding_box_top[ar_object_idx[i]], ar_bounding_box_left[ar_object_idx[i]], ar_bounding_box_width[ar_object_idx[i]] and ar_bounding_box_height[ar_object_idx[i]] syntax elements represent the size and location of an object that may or may not be only partially visible within the cropped decoded picture. When not present, the value of ar_partial_object_flag[ar_object_idx[i]] is inferred from a previous annotated regions SEI message in output order in the CLVS, if any.

Syntax element ar_object_confidence[ar_object_idx[i]] indicates the degree of confidence associated with the ar_object_idx[i]-th object, in units of 2^{-(ar_object_confidence_length_minus1+1)}, such that a higher value of ar_object_confidence[ar_object_idx[i]] indicates a higher degree of confidence. The length of the ar_object_confidence[ar_object_idx[i]] syntax element is ar_object_confidence_length_minus1+1 bits. When not present, the value of_object_confidence[ar_object_idx[i]] is inferred from a previous annotated regions SEI message in output order in the CLVS, if any.

However, there are some problems and limitations of using AR SEI message. In order to improve the video processing, the present disclosure provides a new SEI message called object representation (OR) SEI message. Similar to the AR SEI message, the mechanism of persistence is used in the OR SEI message.

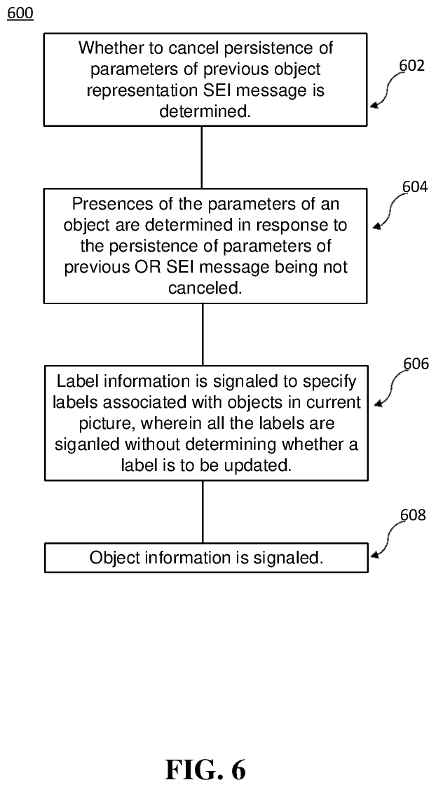

FIG. 6 illustrates a flowchart of an exemplary method 600 for video processing using object representation (OR) SEI message, according to some embodiments of the present disclosure. Method 600 can be performed by an encoder (e.g., by process 200A of FIG. 2A or 200B of FIG. 2B) or performed by one or more software or hardware components of an apparatus (e.g., apparatus 400 of FIG. 4). For example, one or more processors (e.g., processor 402 of FIG. 4) can perform method 600. In some embodiments, method 600 can be implemented by a computer program product, embodied in a computer-readable medium, including computer-executable instructions, such as program code, executed by computers (e.g., apparatus 400 of FIG. 4). Referring to FIG. 6, method 600 may include the following steps 602-608.

At step 602, whether to cancel persistence of parameters of previous object representation SEI message is determined. For example, a cancel flag (e.g., or_cancel_flag) is signaled for indicating whether to cancel persistence of previous object representation SEI message. When the cancel flag being equal to 1 indicates that the object representation SEI message cancels the persistence of parameters of any previous object representation SEI message that is associated with one or more layers to which the object representation SEI message applies. When the cancel flag being equal to 0 indicates that object representation information follows.

At step 604, presences of the parameters of an object are determined in response to the persistence of parameters of previous OR SEI message being not canceled (e.g., the object representation information remains). For example, present flags are signaled to indicate the presence of parameters, such as object depth, object confidence, object primary label, etc. When the parameter is present, length information of the parameter is further signaled to indicate the length of the parameter.

At step 606, label information is signaled to specify labels associated with objects in a current picture. The label information can comprise label controlling flags, label language, label list, etc. The label controlling flags includes but are not limited to flags to indicate whether to update a label, the numbers of labels, etc. The label list can include all the labels.

At step 608, object information is signaled based on the label information. For example, object information can include object index, object label index, object position parameters, and object confidence, etc.

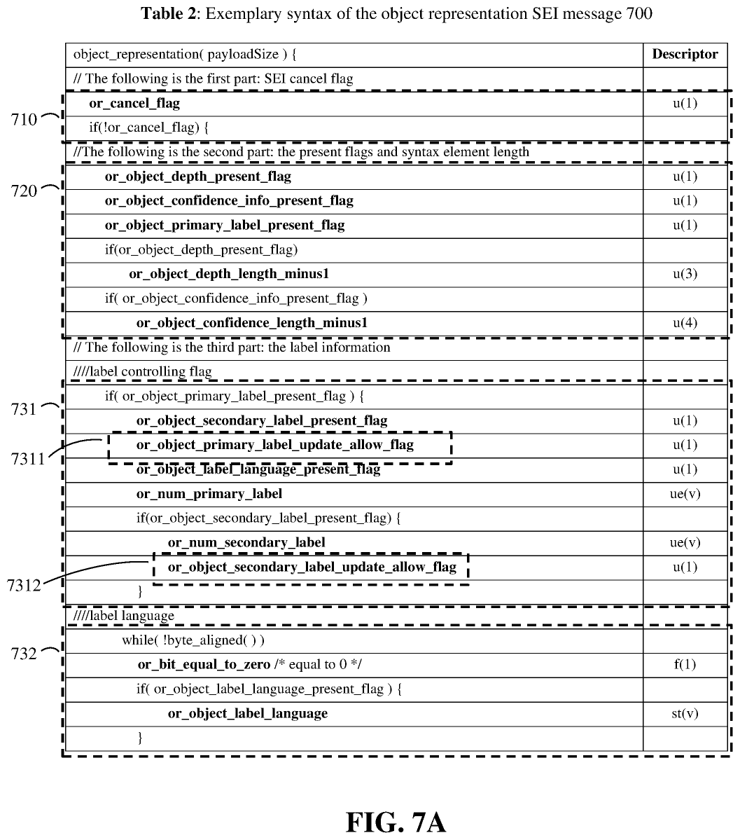

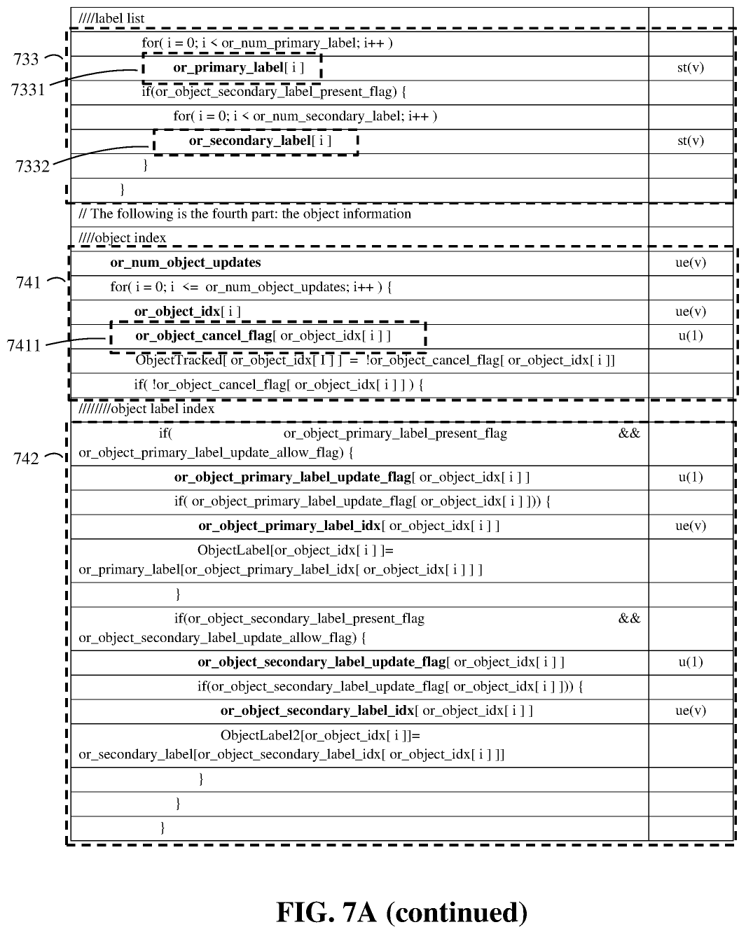

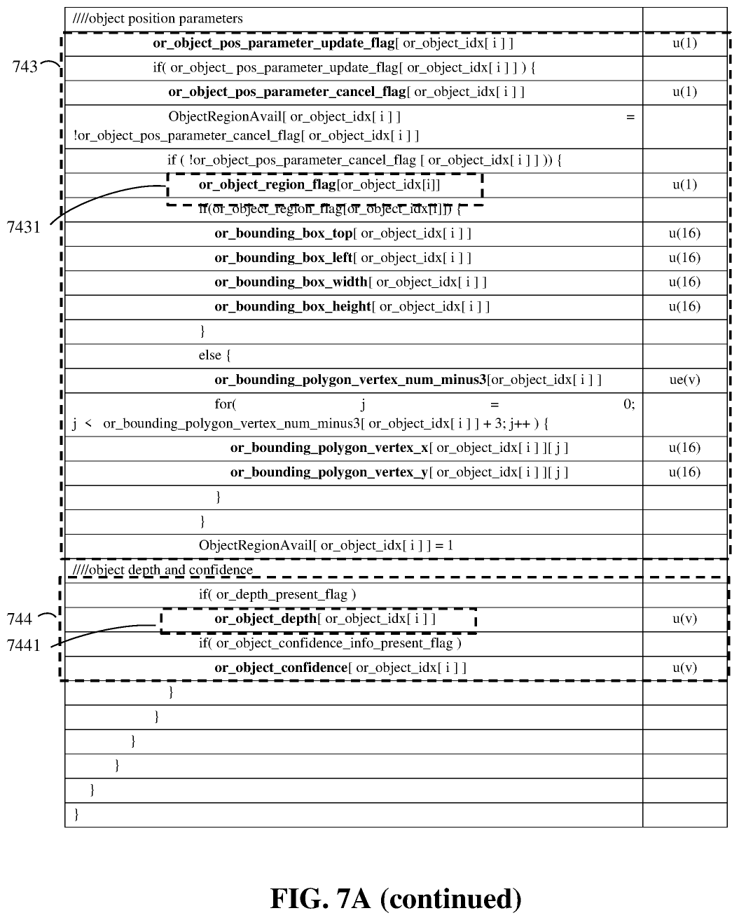

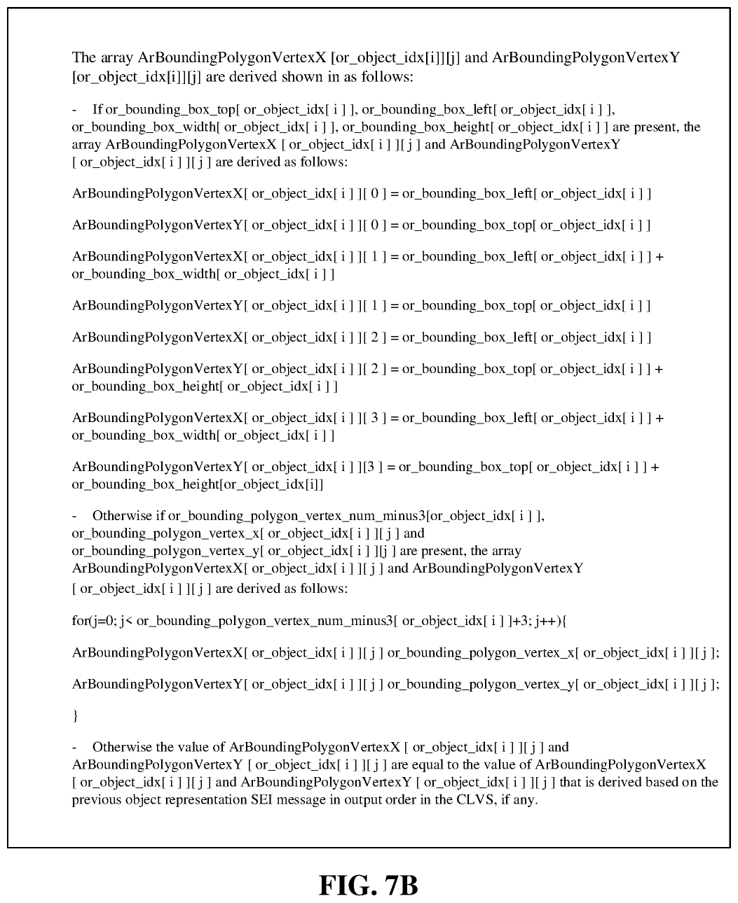

FIG. 7A shows an exemplary syntax 700 of the object representation SEI message, according to some embodiments of the present disclosure. As shown in FIG. 7A, the syntax can comprise four sections: an SEI cancel flag section 710, a present flags and syntax element length section 720, a label information section, and an object information section. The label information section further includes a label controlling flag portion 731, a label language portion 732, and a label list portion 733. The object information section further includes an object index portion 741, an object label index portion 742, an object position parameters portion 743, and an object depth and confidence portion 744.

The semantics of the syntax elements are given below.

Syntax element or_cancel_flag being equal to 1 indicates that the object representation SEI message cancels the persistence of any previous object representation SEI message that is associated with one or more layers to which the object representation SEI message applies. Syntax element or_cancel_flag being equal to 0 indicates that object representation information follows.

When syntax element or_cancel_flag being equal to 1 or a new CLVS of the current layer begins, the variables, ObjectTracked[i], and ObjectRegionAvail[i] are set equal to 0 for i in the range of 0 to 255, inclusive and the variables ObjectLabel[i] and ObjectLabel2[i] are emptied for in the range of 0 t0 255, inclusive.

Let picA be the current picture. Each region identified in the object representation SEI message persists for the current layer in output order until any of the following conditions are true: (i) a new CLVS of the current layer begins; (ii) the bitstream ends; or (iii) a picture picB in the current layer in an access unit containing an object representation SEI message that is applicable to the current layer is output for which PicOrderCnt(picB) is greater than PicOrderCnt(picA), where PicOrderCnt(picB) and PicOrderCnt(picA) are the PicOrderCntVal values of picB and picA, and the semantics of the object representation SEI message for PicB cancels the persistence of the region identified in the object representation SEI message for PicA.

Syntax element or_object_depth_present_flag being equal to 1 indicates that or_object_depth[or_object_idx[i]] syntax elements are present. Syntax element or_object_depth_present_flag being equal to 0 indicates that or_object_depth [or_object_idx[i]] syntax elements are not present. It is a requirement of bitstream conformance that the value of or_object_depth_present_flag is the same for all object_representation( ) syntax structures within a CLVS.

Syntax element or_object_confidence_info_present_flag being equal to 1 indicates that or_object_confidence[or_object_idx[i]] syntax elements are present. Syntax element or_object_confidence_info_present_flag being equal to 0 indicates that or_object_confidence[or_object_idx[i]] syntax elements are not present. It is a requirement of bitstream conformance that the value of or_object_confidence_present_flag is the same for all object_representation( ) syntax structures within a CLVS.

Syntax element or_object_primary_label_present_flag being equal to 1 indicates that primary label information corresponding to the represented objects is present. Syntax element or_object_primary_label_present_flag being equal to 0 indicates that the primary label information corresponding to the represented objects is not present. It is a requirement of bitstream conformance that the value of or_object_primary_label_present_flag is the same for all object_representation( ) syntax structures within a CLVS.

Syntax element or_object_depth_length_minus1+1 specifies the length, in bits, of the or_object_depth[or_object_idx[i]] syntax elements. It is a requirement of bitstream conformance that the value of or_object_depth_length_minus1 is the same for all object_representation( ) syntax structures within a CLVS.

Syntax element or_object_confidence_length_minus1+1 specifies the length, in bits, of the or_object_confidence[or_object_idx[i]] syntax elements. It is a requirement of bitstream conformance that the value of or_object_confidence_length_minus1 is the same for all object_representation( ) syntax structures within a CLVS.

Syntax element or_object_secondary_label_present_flag being equal to 1 indicates that the secondary label information corresponding to the represented objects is present. Syntax element or_object_secondary_label_present_flag being equal to 0 indicates that the secondary label information corresponding to the represented objects is not present. It is a requirement of bitstream conformance that the value of or_object_secondary_label_present_flag is the same for all object_representation( ) syntax structures within a CLVS.

Syntax element or_object_primary_label_update_allow_flag being equal to 1 indicates that the primary label information corresponding to the represented objects the may be updated. Syntax element or_object_primary_label_update_allow_flag being equal to 0 indicates indicates that the primary label information corresponding to the represented objects shall not be updated. It is a requirement of bitstream conformance that the value of or_object_primary_label_update_allow_flag is the same for all object_representation( ) syntax structures within a CLVS.

Syntax element or_object_label_language_present_flag being equal to 1 indicates that the or_object_label_language syntax element is present. Syntax element or_object_label_language_present_flag being equal to 0 indicates that the or_object_label_language syntax element is not present.

Syntax element or_num_primary_label indicates the total number of primary labels associated with the represented objects that are signaled. The value of or_num_primary_label is in the range of 0 to 255, inclusive.

Syntax element or_num_secondary_label indicates the total number of secondary labels associated with the represented objects that are signaled. The value of or_num_secondary_label is in the range of 0 to 255, inclusive.

Syntax element or_object_secondary_label_update_allow_flag being equal to 1 indicates that secondary label information corresponding to the represented object may be updated. Syntax element or_object_secondary_label_update_allow_flag being equal to 0 indicates indicates that secondary label information corresponding to the represented objects shall not be updated. It is a requirement of bitstream conformance that the value of or_object_secondary_label_update_allow_flag is the same for all object_representation( ) syntax structures within a CLVS.

Syntax element or_bit_equal_to_zero is equal to zero.

Syntax element or_object_label_language contains a language tag as specified by IETF (Internet Engineering Task Force) RFC (Requests for Comments) 5646 followed by a null termination byte equal to 0x00. The length of the or_object_label_language syntax element is less than or equal to 255 bytes, not including the null termination byte. When not present, the language of the label is unspecified.

Syntax element or_primary_label[i] specifies the contents of the i-th primary label. The length of the or_primary_label[i] syntax element is less than or equal to 255 bytes, not including the null termination byte.

Syntax element or_secondary_label[i] specifies the contents of the i-th secondary label. The length of the or_secondary_label[i] syntax element is less than or equal to 255 bytes, not including the null termination byte.

Syntax element or_num_object_updates indicates the number of object updates to be signaled. or_num_object_updates is in the range of 0 to 255, inclusive.

Syntax element or_object_idx[i] is the index of the object with which the parameters associated are signaled or canceled. or_object_idx[i] is in the range of 0 to 255, inclusive.

Syntax element or_object_cancel_flag[or_object_idx[i]] being equal to 1 cancels the persistence scope of the or_object_idx[i]-th object. Syntax element or_object_cancel_flag[or_object_idx[i]] being equal to 0 indicates that parameters associated with the or_object_idx[i]-th object may be signaled.

Syntax element or_object_primary_label_update_flag[or_object_idx[i]] being equal to 1 indicates that the primary label associated with the or_object_idx[i]-th object is updated. Syntax element or_object_primary_label_update_flag[or_object_idx[i]] being equal to 0 indicates that the primary label associated with the or_object_idx[i]-th object is not updated.

Syntax element or_object_primary_label_idx[or_object_idx[i]] indicates the index of the primary label associated with the or_object_idx[i]-th object.

Syntax element or_object_secondary_label_update_flag[or_object_idx[i]] being equal to 1 indicates that the secondary label associated with the or_object_idx[i]-th object is updated. Syntax element or_object_secondary_label_update_flag[or_object_idx[i]] being equal to 0 indicates that the secondary label associated with the or_object_idx[i]-th object is not updated.

Syntax element or_object_secondary_label_idx[or_object_idx[i]] indicates the index of the secondary label associated with the or_object_idx[i]-th object.

Syntax element or_object_pos_parameter_update_flag[or_object_idx[i]] being equal to 1 indicates that the position parameter associated with the or_object_idx[i]-th object is updated. Syntax element or_object_pos_parameter_update_flag[or_object_idx[i]] being equal to 0 indicates that the position parameter associated with the or_object_idx[i]-th object is not updated.

Syntax element or_object_pos_parameter_cancel_flag[or_object_idx[i]] being equal to 1 cancels the persistence scope of the object parameters, including or_bounding_box_top[or_object_idx[i]], or_bounding_box_left[or_object_idx[i]], or_bounding_box_width[or_object_idx[i]], or_bounding_box_height[or_object_idx[i]], or_bounding_polygon_vertex_num_minus3[or_object_idx[i]], or_bounding_polygon_vertex_x[or_object_idx[i]][j], or_bounding_polygon_vertex_y[or_object_idx[i]][j] for j in the range of 0 to or_bounding_polygon_vertex_num_minus3[or_object_idx[i]]+2, inclusive, or_object_depth[or_object_idx[i]] and or_object_confidence[or_object_idx[i]]. Syntax element or_bounding_box_cancel_flag[or_object_idx[i]] being equal to 0 indicates that or_bounding_box_top[or_object_idx[i]], or_bounding_box_left[or_object_idx[i]], or_bounding_box_width[or_object_idx[i]], or_bounding_box_height[or_object_idx[i]], or_bounding_polygon_vertex_num_minus3[or_object_idx[i]], or or_bounding_polygon_vertex_x[or_object_idx[i]][j], or_bounding_polygon_vertex_y[or_object_idx[i]][j] for j in the range of 0 to or_bounding_polygon_vertex_num_minus3[or_object_idx[i]]+2, inclusive, are signaled, and or_object_depth[or_object_idx[i]] and or_object_confidence[or_object_idx[i]] syntax elements are signaled.

Syntax element or_object_region_flag[or_object_idx[i]] being equal to 1 specifies or_bounding_box_top[or_object_idx[i]], or_bounding_box_left[or_object_idx[i]], or_bounding_box_width[or_object_idx[i]] or_bounding_box_height[or_object_idx[i]] are present, or_bounding_polygon_vertex_num_minus3[or_object_idx[i]], or_bounding_polygon_vertex_x[or_object_idx[i]][j], or_bounding_polygon_vertex_y[or_object_idx[i]][j] for j in the range of 0 to or_bounding_polygon_vertex_num_minus3[or_object_idx[i]]+2, inclusive, are not present. Syntax element or_object_region_flag[or_object_idx[i]] being equal to 0 specifies that or_bounding_box_top[or_object_idx[i]], or_bounding_box_left[or_object_idx[i]], or_bounding_box_width[or_object_idx[i]], or_bounding_box_height[or_object_idx[i]] are not present, or_bounding_polygon_vertex_num_minus3[or_object_idx[i]], or_bounding_polygon_vertex_x[or_object_idx[i]][j], or_bounding_polygon_vertex_y[or_object_idx[i]][j] for j in the range of 0 to or_bounding_polygon_vertex_num_minus3[or_object_idx[i]]+2, inclusive, are present.

Syntax elements or_bounding_box_top[or_object_idx[i]], or_bounding_box_left[or_object_idx[i]], or_bounding_box_width[or_object_idx[i]], and or_bounding_box_height[or_object_idx[i]] specify the coordinates of the top-left corner and the width and height, respectively, of the bounding box of the or_object_idx[i]-th object in the cropped decoded picture, relative to the conformance cropping window specified by the active SPS.

Let croppedWidth and croppedHeight be the width and height, respectively, of the cropped decoded picture in units of luma samples.

The value of or_bounding_box_left[or_object_idx[i]] is in the range of 0 to croppedWidth/SubWidthC-1, inclusive.

The value of or_bounding_box_top[or_object_idx[i]] is in the range of 0 to croppedHeight/SubHeightC-1, inclusive.

The value of or_bounding_box_width[or_object_idx[i]] is in the range of 0 to croppedWidth/SubWidthtC-or_bounding_box_left[or_object_idx[i]], inclusive.

The value of or_bounding_box_height[or_object_idx[i]] is in the range of 0 to croppedHeight/SubHeightC-or_bounding_box_top[or_object_idx[i]], inclusive.

The values of or_bounding_box_top[or_object_idx[i]], or_bounding_box_left[or_object_idx[i]], or_bounding_box_width[or_object_idx[i]] and or_bounding_box_height[or_object_idx[i]] persist in output order within the CLVS for each value of or_object_idx[i] with which a bounding box is associated.

Syntax element or_bounding_polygon_vertex_num_minus3[or_object_idx[i]] plus 3 specifies the number of vertex of the bounding polygon associated with or_object_idx[i]-th object in the cropped decoded picture, relative to the conformance cropping window specified by the active SPS.

Syntax elements or_bounding_polygon_vertex_x[or_object_idx[i]][j], or_bounding_polygon_vertex_y[or_object_idx[i]][j] specify the coordinates of the j-th vertex of bounding polygon associated the or_object_idx[i]-th object in the cropped decoded picture, relative to the conformance cropping window specified by the active SPS.

The value of or_bounding_polygon_vertex_x[or_object_idx[i]][j] is in the range of 0 to croppedWidth/SubWidthC-1, inclusive.

The value of or_bounding_polygon_vertex_y[or_object_idx[i]][j] is in the range of 0 to croppedHeight/SubHeightC-1, inclusive.

The values of or_bounding_polygon_vertex_x[or_object_idx[i]][j] and or_bounding_polygon_vertex_y[or_object_idx[i]][j] persist in output order within the CLVS for each value of or_object_idx[i] with which a bounding polygon is associated.

FIG. 7B shows an example pseudocode including derivation for array ArBoundingPolygonVertexX [or_object_idx[i]][j] and ArBoundingPolygonVertexY [or_object_idx[i]]][j], according to some embodiments of the present disclosure.

The array ArBoundingPolygonVertexX [or_object_idx[i]][j] and ArBoundingPolygonVertexY [or_object_idx[i]][j] are derived as shown in FIG. 7B.

The value of ArBoundingPolygonVertexX [or_object_idx[i]][j] is in the range of 0 to croppedWidth/SubWidthC-1, inclusive.

The value of ArBoundingPolygonVertexY [or_object_idx[i]][j] is in the range of 0 to croppedHeight/SubHeightC-1, inclusive.

Syntax element or_object_depth[or_object_idx[i]] specifies the depth associated with the or_object_idx[i]-th object. When not present, the value of_object_depth[or_object_idx[i]] is inferred from a previous object representation SEI message in output order in the CLVS, if any.

Syntax element or_object_confidence[or_object_idx[i]] indicates the degree of confidence associated with the or_object_idx[i]-th object, in units of 2^{-(or_object_confidence_length_minus1+1)}, such that a higher value of or_object_confidence[or_object_idx[i]] indicates a higher degree of confidence. The length of the or_object_confidence[or_object_idx[i]] syntax element is or_object_confidence_length_minus1+1 bits. When not present, the value of_object_confidence[or_object_idx[i]] is inferred from a previous object representation SEI message in output order in the CLVS, if any.

In the current AR SEI message, when signaling the label information, the persistence mechanism is used. If the label list is changed, only the changed labels are signaled in the new AR SEI message. The current syntax supports cancelling a label which is not used any more and adding a new label which is to be used for the first time. However, in common cases, the number of the labels for the CLVS is a relatively small number, which means signalling all the labels in a new AR SEI message even if only some of labels are changed doesn't take much signaling overhead. With the OR SEI message, a more straightforwad way for label signaling is provided according to some embodiments of the present disclosure, which can be expressed with fewer syntax elements.

In some embodiments, at step 606, all the labels are signaled without determining whether a label is to be updated. In this embodiment, the whole label list is signaled, including the labels to be updated and labels not to be updated.

As shown in FIG. 7A, the label information syntax section is simplified compared with the syntax 500 in FIG. 5, and a label cancel flag (e.g., or_label_cancel_flag), a label index (e.g., or_label_indx[ ]) and the array LabelAssigned[ ] are not needed any more (referring to block 510 in FIG. 5).

With signaling all the labels without checking whether a label to be updated or not, fewer syntax element is signaled, therefore simplifying the video processing.

For some common use cases, the label is a category of the object, such as “people,” “vehicle.” Thus, it is not necessary to change label information of an object in these cases. However, in the current AR SEI message, the syntax element ar_object_label_update_flag 520 (as shown in FIG. 5) which indicates whether to update the label information of an object is always signaled if the object is not canceled.

In some embodiments, the step 606 in method 600 further includes a step of determining whether a label is allowed to be update prior to updating the label. Referring back to FIG. 7A, two flags for indicating whether it is allowed to update the primary label information and the secondary label information for an object, respectively, are signaled. For example, syntax element or_object_primary_label_update_allow_flag 7311 and or_object_secondary_label_update_allow_flag 7312 are signaled in label controlling flag portion 731. If the primary label or the secondary label of an object is allowed to be updated, the corresponding label information of an object may be updated in the following OR SEI message. Otherwise, the label information of the object should not change within a CLVS. In some embodiments, in the application for which labels are fixed throughout, the encoder (e.g., process 200A of FIG. 2A or 200B of FIG. 2B) can set that the primary label information and the secondary label information for an object are not allowed to update. For example, the encoder can set or_object_primary_label_update_allow_flag 7311 and or_object_secodnary_label_update_allow_flag 7312 to be 0. With this condition, label information can be updated only when the label is allowed to be updated, and there is no update information signaled if the labels are not allowed to be updated. Therefore, since labels are not updated frequently, the signaling is reduced.

In the current AR SEI message, when signaling the parameters of object, ar_object_cancel_flag 540 (as shown in FIG. 5) is signaled to indicate whether to cancel the object parameter or not. Even for the object that is newly added in the current SEI message, this flag is still signaled and can be equal to 1. It doesn't make sense to cancel a new object that newly appears in the current picture. Also, in the current syntax of AR SEI message, it is allowed to not assign a label or define the bounding box for a new object. In that case, the decoder can only know that there is a new object in this picture but doesn't have any information about the object.

The present disclosure provides embodiments for signaling conditions for object information.

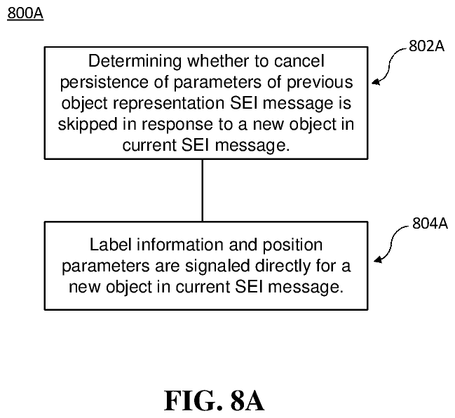

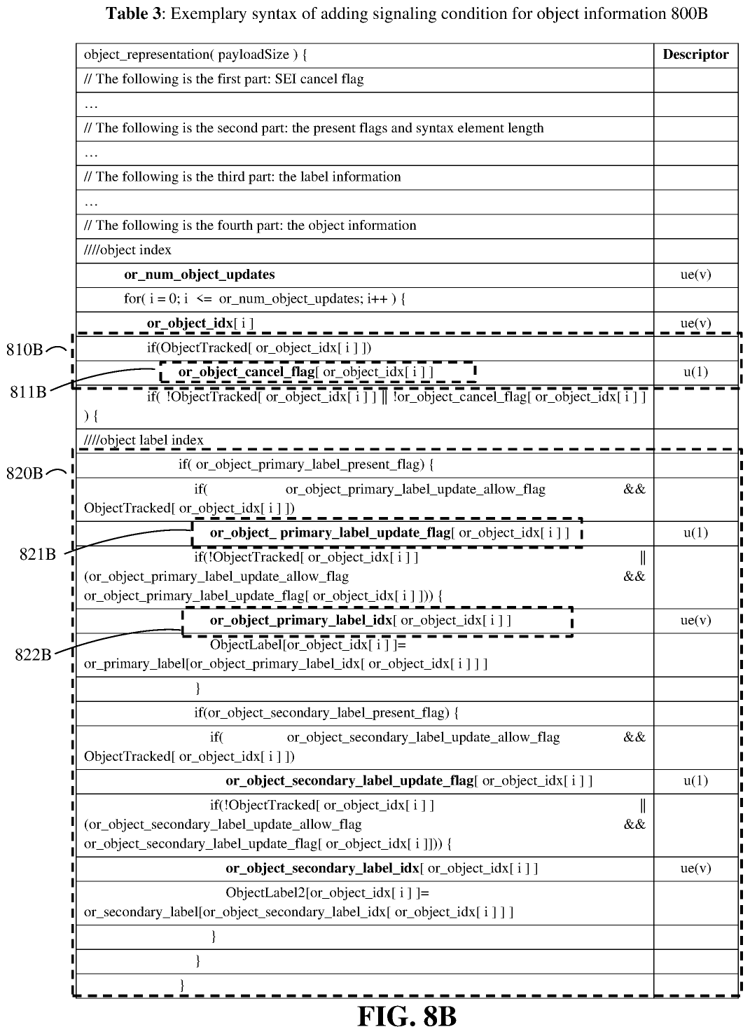

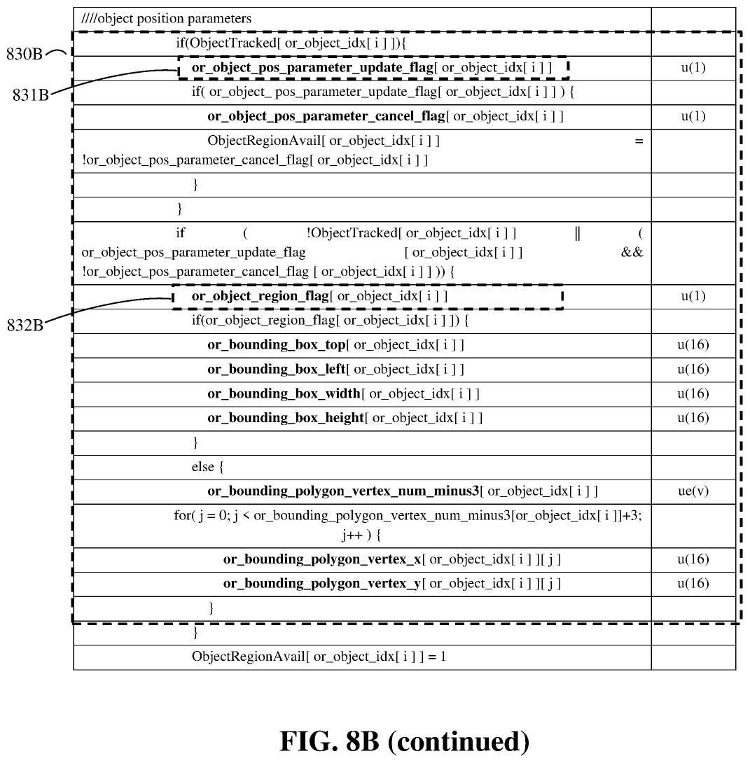

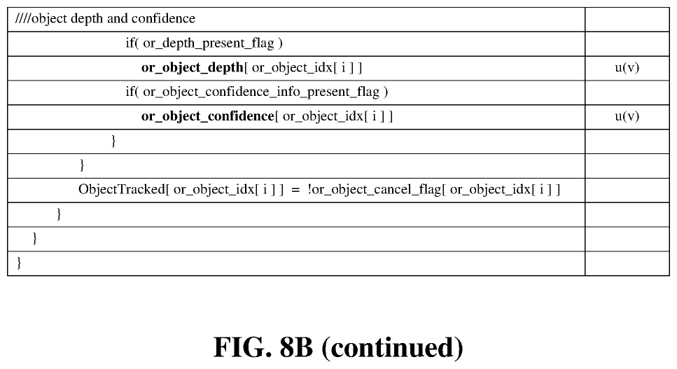

FIG. 8A illustrates a flowchart of an exemplary method 800A for video processing using object representation SEI message, according to some embodiments of the present disclosure. Method 800A can be performed by an encoder (e.g., by process 200A of FIG. 2A or 200B of FIG. 2B) or performed by one or more software or hardware components of an apparatus (e.g., apparatus 400 of FIG. 4). For example, one or more processors (e.g., processor 402 of FIG. 4) can perform method 800A. In some embodiments, method 800A can be implemented by a computer program product, embodied in a computer-readable medium, including computer-executable instructions, such as program code, executed by computers (e.g., apparatus 400 of FIG. 4). Referring to FIG. 8A, method 800A may include the following steps 802A and 804A.

At step 802A, determining whether to cancel persistence of parameters of previous object representation SEI message is skipped in response to a new object in current SEI message. That is, signaling a cancel flag is skipped for a new object in current SEI message. The cancel flag is signaled only when the object is previously present, which means the object is a tracked object.

At step 804A, label information and position parameters are signaled directly for a new object in current SEI message. Therefore, signaling flags to indicate parameter and label update is skipped for a new object in current SEI message. The flags to indicate parameter and label update are signaled only when the object is previously present.

FIG. 8B shows an exemplary portion of syntax structure 800B of adding signaling condition for object information, according to some embodiments of the present disclosure. The syntax structure 800B can be used in method 800A. Syntax structure 800B only shows the changes made to syntax structure 700. The changes from the syntax structure 700 are shown in block 810B-830B.

Referring to 810B, syntax element or_object_cancel_flag[or_object_idx[i]] 811B is signaled only when the object is already present in current SEI message the (e.g., ObjectTracked [or_object_idx[i]] being equal to 1). Therefore, for a new object, syntax element or_object_cancel_flag 811B is not signaled. Referring to 820B and 830B, signaling conditions are added for signaling object index and object position parameters. The object information is signaled directly when the object is new (e.g., ObjectTracked [or_object_idx[i]] being equal to 0). Update flag is signaled when the object is already present in current SEI message the (e.g., ObjectTracked [or_object_idx[i]] being equal to 1). For example, syntax element or_object_primary_label_idx[or_object_idx[i]] 822B and or_object_region_flag [or_object_idx[i]] 832B are signaled directly when the object is new (e.g., ObjectTracked [or_object_idx[i]] being equal to 0). Syntax element or_object_primary_label_update_flag[or_object_idx[i]] 821B and or_object_pos_parameter_update_flag[or_object_idx[i]] 831B are signaled only when the object is already present in current SEI message the (e.g., ObjectTracked [or_object_idx[i]] being equal to 1).

In the embodiment shown in syntax structure 700 in FIG. 7A, when signaling object information, the object label information is signaled followed by object position parameters. When signaling object label information, a flag indicating whether label information associated with the object is updated is signaled first. If the label information associated with the object is updated, a new label index is signaled. Similarly, when signaling object position parameters, a flag indicating whether position parameters are updated is signaled first. If the position parameters are updated, the updated object position parameters are signaled. The syntax structure 700 allows that both object label information and position parameters are not updated. However, the AR SEI messages use persistence mechanism, so only the object to be updated is signaled. That is, it is allowed that an object is signaled to be updated but actually none of label information and position is updated. It is a very weird case.

In some embodiments of the present disclosure, it is proposed to signaling object label information based on object position parameters. Therefore, the object position parameters are signaled before object label information. When object position parameters are not updated, the signaling of a flag which indicates whether updates the label information or not is skipped and the label information is updated directly. This way, it is guaranteed that at least one of object label information and object position parameters is updated for an object to be updated.

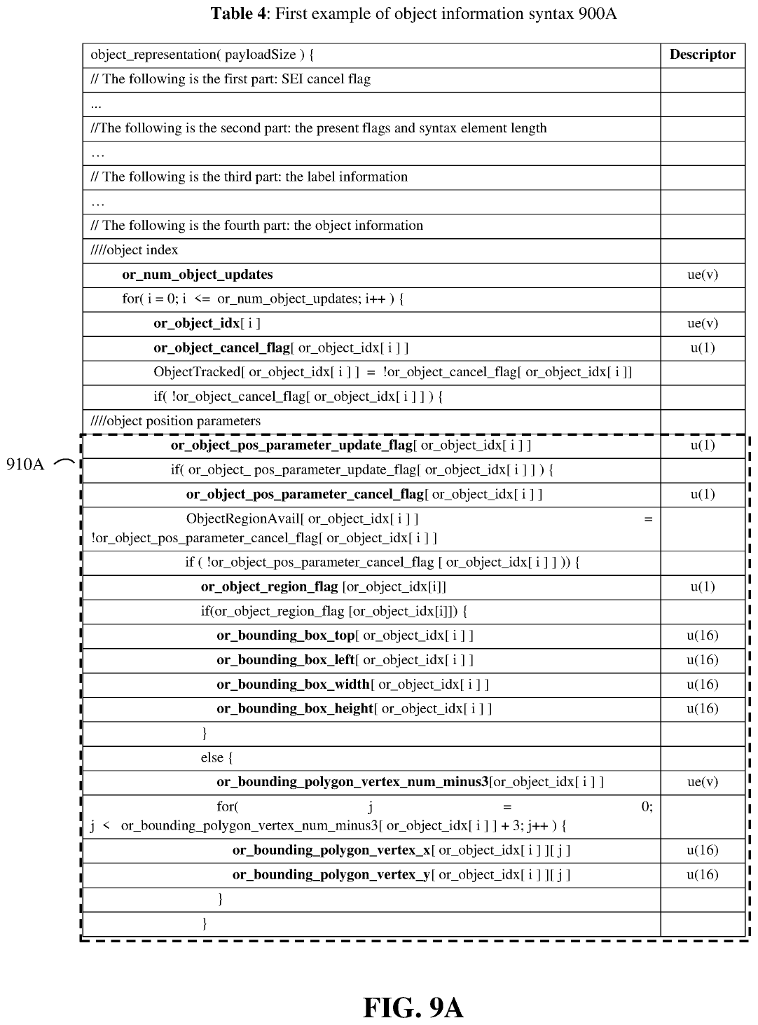

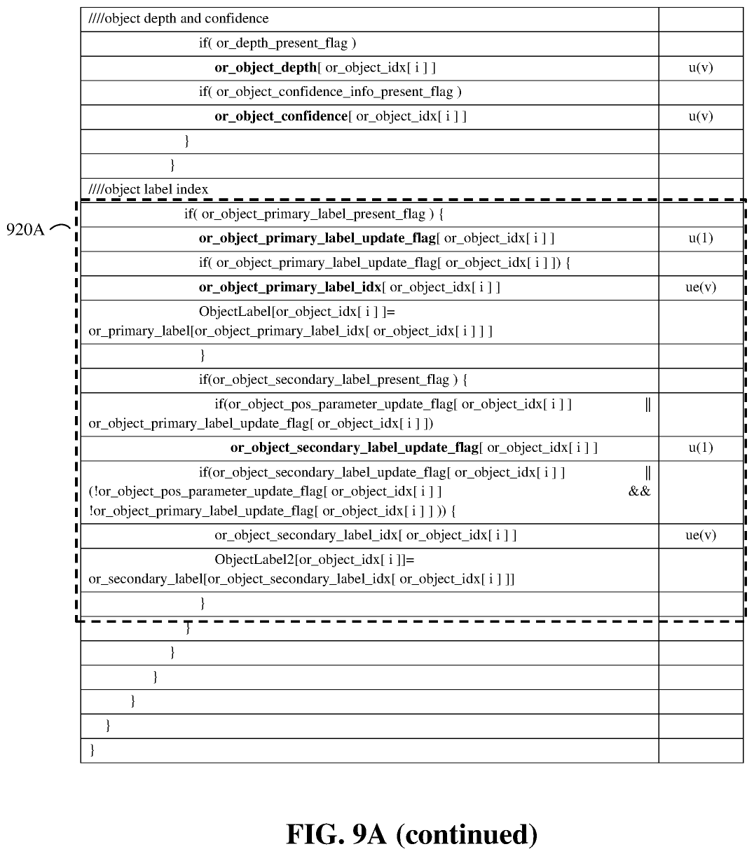

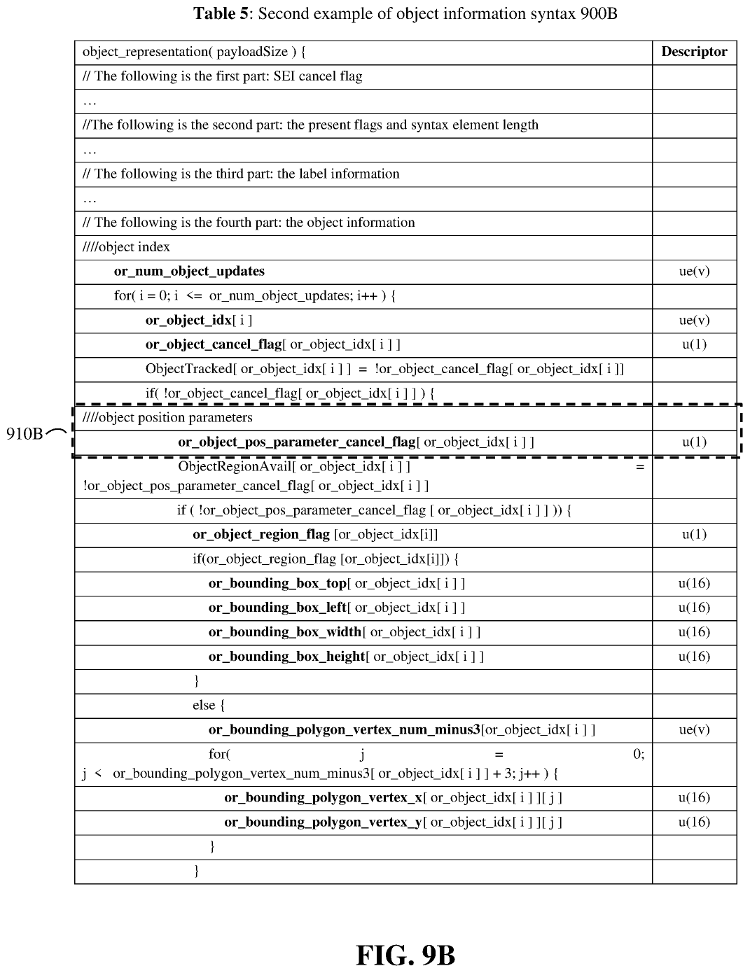

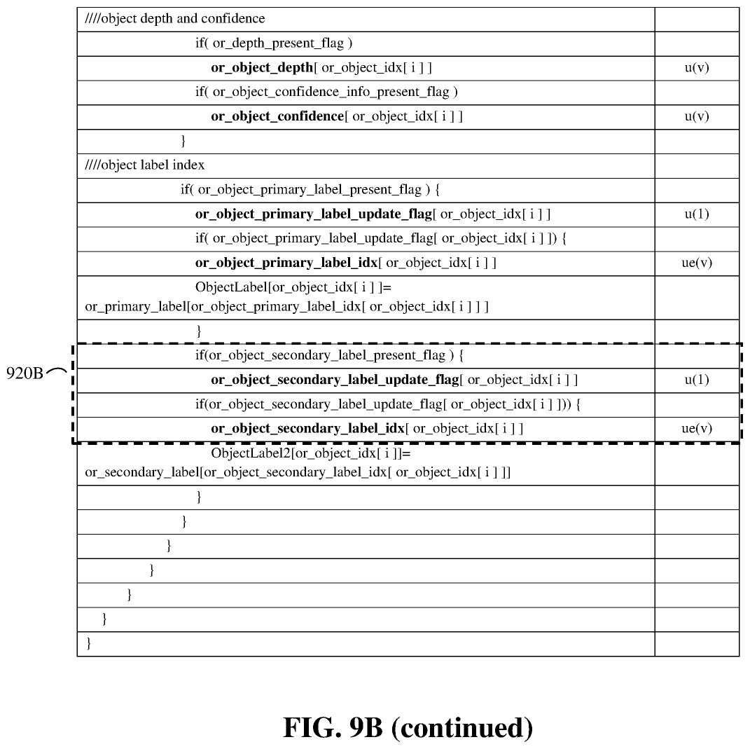

FIG. 9A illustrates an exemplary portion of syntax structure 900A for signaling object position parameters and object label information, according to some embodiments of the present disclosure. Syntax structure 900A only shows the changes made to syntax structure 700. The changes from the syntax structure 700 are shown in block 910A and 920A.

Referring to FIG. 9A, object label index portion 920A is signaled after object position parameters portion 910A. The syntax element or_object_primary_label_update_allow_flag and or_object_secondar_label_update_allow_flag are not signaled, neither determined for signaling the object label index. Therefore, the syntax is simplified.

Usually, the label of an object is more stable than the position of the object. Especially when the position of an object keeps the same, the possibility of the label of the object being changed is quite small.

In some embodiments, the present disclosure proposed to remove the flag which indicates whether the object position parameters are updated or not, but directly update parameters of the object. By doing this, there is also no need to check whether the object position parameters are updated or not when signaling the object label information, because it is assumed that the object position parameters are always updated.

FIG. 9B illustrates another exemplary portion of syntax structure 900B for signaling object position parameters and object label information, according to some embodiments of the present disclosure. Syntax structure 900B only shows the changes made to syntax structure 900A. The changes from the syntax structure 900A are shown in block 910B and 920B.

Referring to FIG. 9B, as shown in 910B, syntax element or_object_pos_paramter_update_flag[or_object_idx[i]] is not signaled. And as shown in 920B, the value of or_object_pos_paramter_update_flag[or_object_idx[i]] and the value of or_object_primary_label_update_flag[or_object_idx[i]] are no more determined for signaling or_object_secondary_label_update_flag[or_object_idx[i]] and or_object_secondary_label_idx[or_object_idx[i]]. Therefore, the syntax is further simplified.

In the current AR SEI message, only single label is supported. However, in a real application, multiple labels may need to be assigned to an object. For example, some applications may need to detect “people” and “vehicle” in a street scene. At the same time, it also needs to distinguish people who are lying on the street as opposed to people who are walking on the street, as the former may indicate an accident that needs medical attention. In the case of a vehicle, it may be desirable to distinguish the colors. In general, it may be desirable to have the ability to attach more than one label to an object. For example, the first label dimension can be “people” and “vehicle;” the second label dimension can be “lying,” “standing” and “walking;” and the third label dimension can be “red,” “yellow,” “blue,” and so on.

Referring back to FIG. 7A, in some embodiments, multiple labels are provided for an object. For example, a primary label (e.g., or_primary_label[i] 7331) and a secondary label (e.g., or_secondary_label[i] 7332) can be applied to one object. The secondary label can be present only when the primary label is present. For example, The primary label can be “people” and “vehicle”, and the secondary label can be “lying”, “standing,” and “walking” for “people;” or “red,” “yellow,” and “blue” for “vehicle.” One object can have one or more labels. If only a primary label is present, the object has only one label. For the case where both of these two labels are present, there are two labels for each object. In some embodiments, a third label can be applied. For example, a third label can be “male” and “female” for “walking” “people”. The third label can be independent from the second label. In this case, the two labels for an object can be a primary label and a second label or a third label. For example, an object may have labels “people” and “male”. In some embodiments, the third label can be dependent on the second label. In this case, only when the second label is present, the third label is present. For example, an object may have labels “people”, “walking” and “male”. The number of labels can be dependent on the requirement of the accuracy for an object.

An object with multiple labels can be represented more accurate, therefore the accuracy of video processing is improved.

In the embodiments described above, for example, to support two labels for one object, totally two label lists are signaled. Thus, all the objects share the same primary label list and share the same secondary label list. That is, regardless of the primary label, each object has the same secondary label space. However, in practice, objects with different primary labels may have different secondary labels. For example, for “people”, the action or pose are important information for image processing; for “vehicle”, the shape or color are important information for image processing. That is, for the object with primary label of “people”, the secondary list may be “walking”, “standing”, “lying”, “sitting”, while for the object with primary label of “vehicle”, the secondary label may be “red”, “blue”, “yellow”, and so on.

Thus, primary label dependent secondary label can be used in some embodiments according to the present disclosure. For each of primary label in the primary label list, there is a separated corresponding secondary label list.

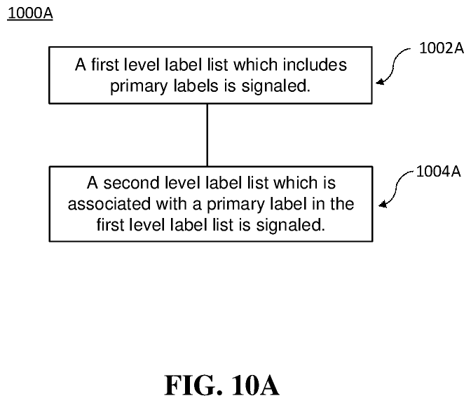

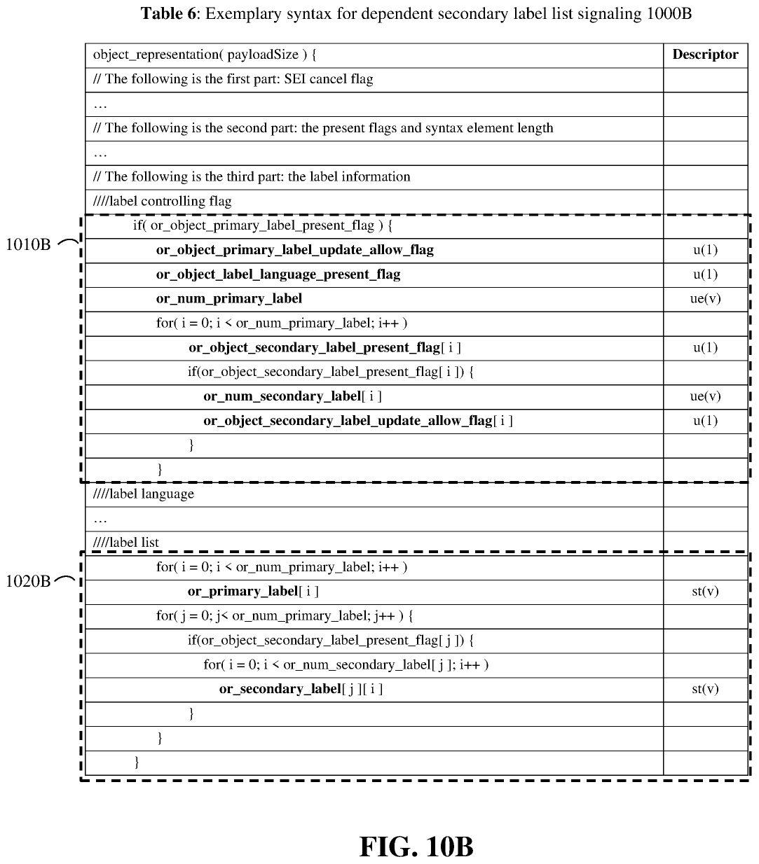

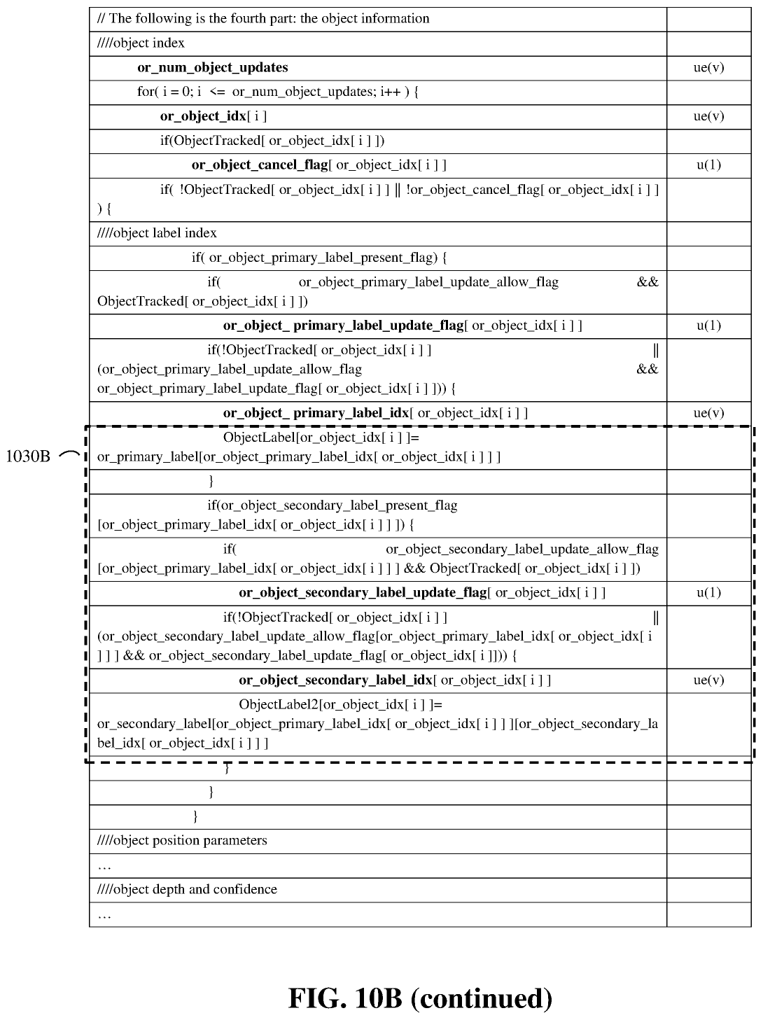

FIG. 10A illustrates a flowchart of an exemplary method 1000A for dependent secondary label lists, according to some embodiments of the present disclosure. Method 1000A can be performed by an encoder (e.g., by process 200A of FIG. 2A or 200B of FIG. 2B) or performed by one or more software or hardware components of an apparatus (e.g., apparatus 400 of FIG. 4). For example, one or more processors (e.g., processor 402 of FIG. 4) can perform method 1000A. In some embodiments, method 1000A can be implemented by a computer program product, embodied in a computer-readable medium, including computer-executable instructions, such as program code, executed by computers (e.g., apparatus 400 of FIG. 4). Referring to FIG. 10A, method 1000A may include the following steps 1002A and 1004A.

At step 1002A, a first level label list which includes primary labels is signaled. For example, the first level label list can include a plurality of labels, such as “people”, “vehicle”, and etc.

At step 1004A, a second level label list which is associated with a primary label in the first level label list is signaled. Each primary label can have a separated corresponding second level label list. And each second level label list can include a plurality of labels. For example, for primary label “people”, the second level label list associated with the primary label can include labels such as “walking”, “standing”, “lying”, “sitting”. For primary label “vehicle”, the second level label list associated with the primary label can include labels such as “red”, “blue”, “yellow”. Then, when signaling a secondary label for an object, the secondary label signaled for an object is selected from the second level label list associated with the primary label of the object. Therefore, the efficiency of signaling a secondary label for an object is improved.

FIG. 10B shows an exemplary portion of syntax structure 1000B of dependent secondary label lists, according to some embodiments of the present disclosure. The syntax structure 1000B can be used in method 1000A. Syntax structure 1000B only shows the changes made to syntax structure 800B. The changes from the syntax structure 800B are shown in block 1010B-1030B. The updated semantics of the syntax structure 1000B are as follows.

Syntax element or_object_secondary_label_present_flag[i] being equal to 1 indicates that the secondary label information corresponding to the represented objects with the i-th primary label is present. Syntax element or_object_secondary_label_present_flag being equal to 0 indicates that the secondary label information corresponding to the represented objects with the i-th primary label is not present. It is a requirement of bitstream conformance that the value of or_object_secondary_label_present_flag is the same for all object_representation( ) syntax structures within a CLVS.

Syntax element or_num_secondary_label[i] indicates the number of secondary labels associated with the represented objects with the i-th primary label. The value of or_num_secondary_label[i] is in the range of 0 to 255, inclusive.

Syntax element or_object_secondary_label_update_allow_flag[i] being equal to 1 indicates that secondary label information corresponding to the object with the i-th primary label may be updated. Syntax element or_object_secondary_label_update_allow_flag[i] being equal to 0 indicates that secondary label information corresponding to the object with the i-th primary label shall not be updated. It is a requirement of bitstream conformance that the value of or_object_secondary_label_update_allow_flag[i] is the same for all object representation( ) syntax structures within a CLVS.

Syntax element or_secondary_label[j][i] specifies the contents of the i-th secondary label associated with the object with j-th primary label. The length of the or_secondary_label[j][i] syntax element is less than or equal to 255 bytes, not including the null termination byte.

Referring to FIG. 10B, as shown in 1010B, label controlling flags for secondary label are signaled associated with a primary label. As shown in 1020B, separated secondary label lists are signaled for corresponding primary label. Then, the secondary label can be signaled or updated from the secondary label list which is associated with the primary label signaled, as shown in 1030B.

In some embodiments, to support two labels for one object, two label lists are signaled. The present disclose also provides embodiments in which only one label list is signaled and both the primary label and the secondary label of an object are picked up from this label list.

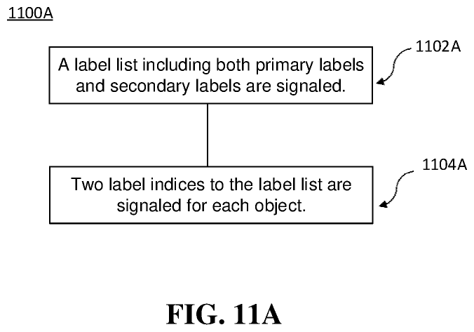

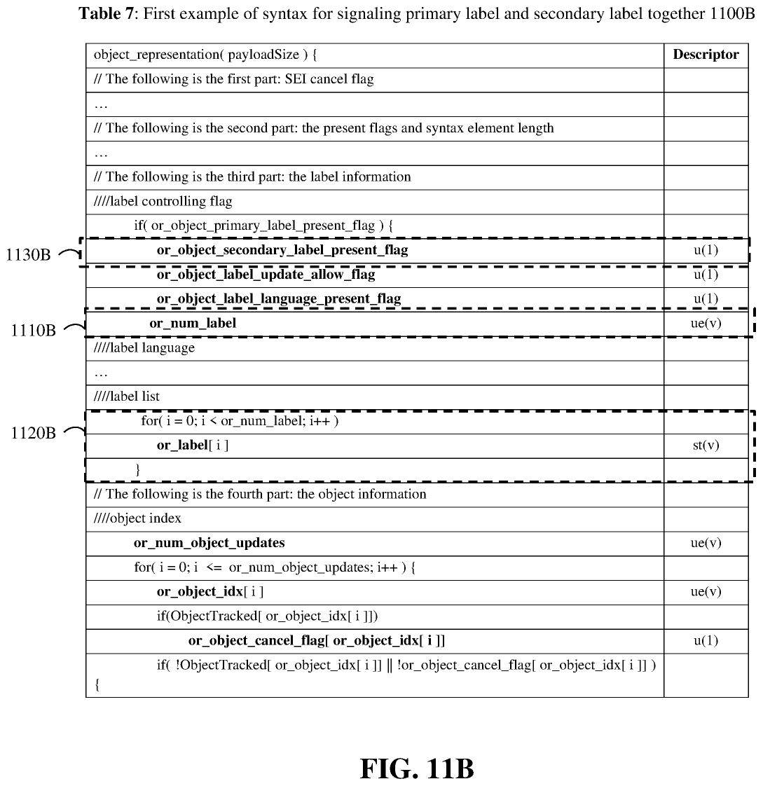

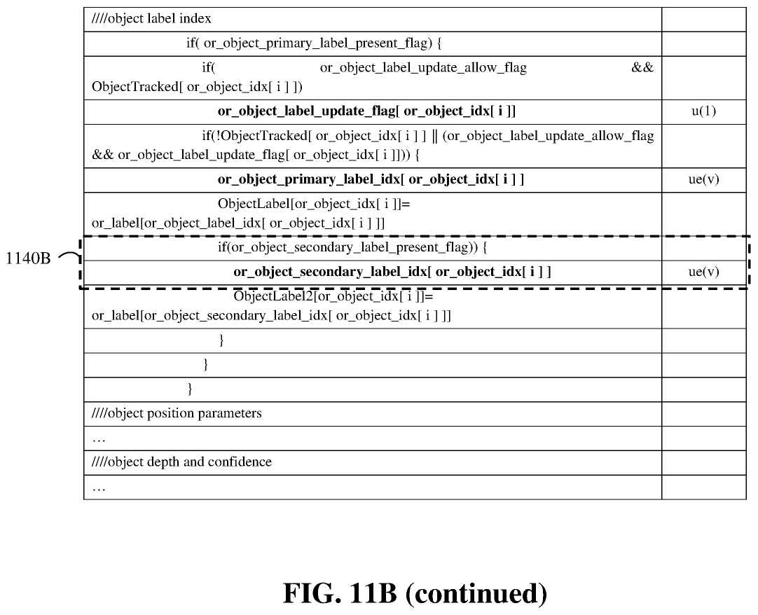

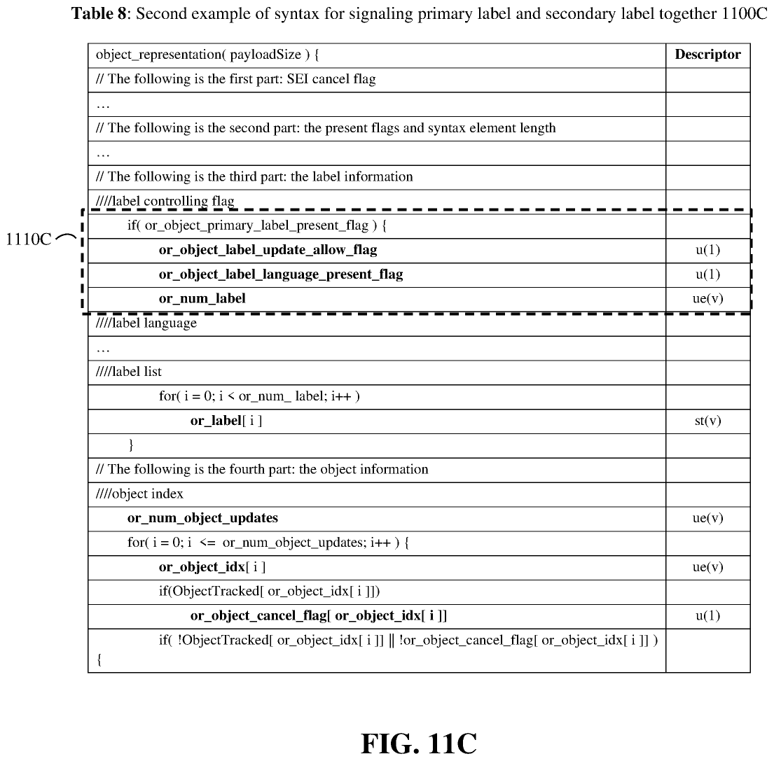

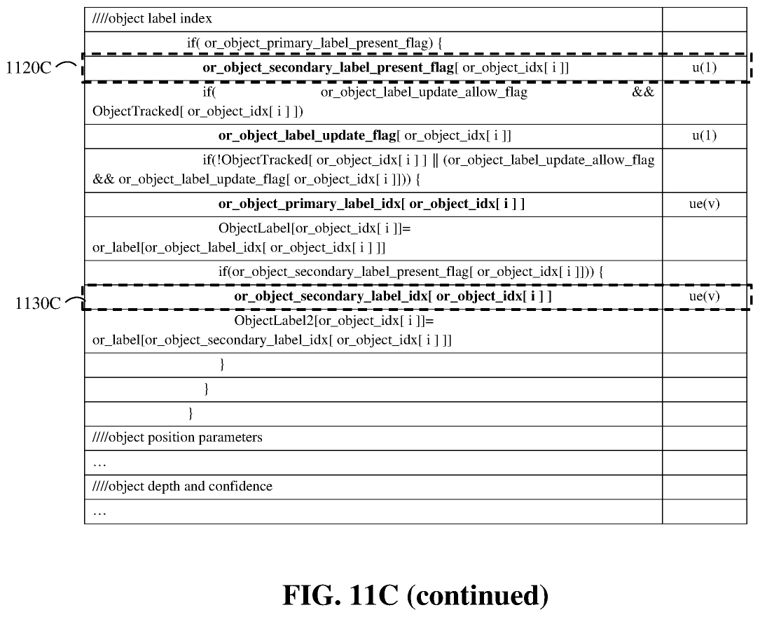

FIG. 11A illustrates a flowchart of an exemplary method 1100A for video processing using combined label list, according to some embodiments of the present disclosure. Method 1100A can be performed by an encoder (e.g., by process 200A of FIG. 2A or 200B of FIG. 2B) or performed by one or more software or hardware components of an apparatus (e.g., apparatus 400 of FIG. 4). For example, one or more processors (e.g., processor 402 of FIG. 4) can perform method 1100A. In some embodiments, method 1100A can be implemented by a computer program product, embodied in a computer-readable medium, including computer-executable instructions, such as program code, executed by computers (e.g., apparatus 400 of FIG. 4). Referring to FIG. 11A, method 1100A may include the following steps 1102A and 1104A.

At step 1102A, a label list including both primary labels and secondary labels are signaled. For example, in the street scene, the primary label may be {“people”, “vehicle” }. For people, it is necessary to describe the action like “standing”, “lying” or “walking”, for the vehicle, it is necessary to describe the colors. Thus, for the people, the secondary label may be {“standing”, “lying”, “walking” } and for the vehicle, the secondary label may be {“red”, “yellow”, “blue” }. In the syntax of the embodiment shown in FIGS. 7A-7C, one primary label list as {“people”, “vehicle” } and one secondary label list as {“standing”, “lying”, “walking”, “red”, “yellow”, “blue” } are signaled. In the syntax of dependent secondary label lists shown in FIGS. 10B and 10C, a primary label list as {“people”, “vehicle” }, two secondary label lists as {“standing”, “lying”, “walking” } and {“red”, “yellow”, “blue” } which corresponds to each of the two primary labels respectively are signaled. In the combined-label-list embodiments, only one combined label list as {“people”, “vehicle”, “standing”, “lying”, “walking”, “red”, “yellow”, “blue” } is signaled.

At step 1104A, two label indices to the label list are signaled for each object. The two label indices correspond to the primary and secondary labels, respectively. Normally, the two label indices are different.

FIG. 11B shows an exemplary portion of syntax structure 1100B of combined label list, according to some embodiments of the present disclosure. The syntax structure 1100B can be used in method 1100A. Syntax structure 1100B only shows the changes made to syntax structure 800B. The changes from the syntax structure 800B are shown in block 1110B-1140B.

Referring to FIG. 11B, syntax element or_object_primary_label_present_flag being equal to 1 indicates that the or_object_primary_label_idx may be present. Syntax element or_object_label_present_flag being equal to 0 indicates syntax element or_object_primary_label_idx is not present. It is a requirement of bitstream conformance that the value of or_object_primary_label_present_flag is the same for all object_representation( ) syntax structures within a CLVS.

Syntax element or_object_primary_label_idx[or_object_idx[i]] indicates the index of the primary label associated with the or_object_idx[i]-th object.

Syntax element or_object_secondary_label_present_flag being equal to 1 indicates that the or_object_secondray_label_idx may be present. Syntax element or_object_secondary_label_present_flag being equal to 0 indicates or_object_secondary_label_idx is not present. It is a requirement of bitstream conformance that the value of or_object_secondary_label_present_flag is the same for all object_representation( ) syntax structures within a CLVS.

Syntax element or_object_secondary_label_idx [or_object_idx[i]] indicates the index of the secondary label associated with the or_object_idx[i]-th object.

Referring to FIG. 11B, as shown in 1110B and 1120B, a label list including all the labels (e.g., or_label[i]) is signaled.

In some embodiments, as shown in 1130B and 1140B secondary label present flag is shared by all the objects. For example, syntax element or_object_secondary_label_present_flag 1130B is signaled to indicate the presence of secondary label all the objects. If or_object_secondary_label_present_flag 1130B is equal to 1, secondary labels are present for all the labels. Therefore, the secondary label index is signaled for every object. If or_object_secondary_label_present_flag 1130B is equal to 0, there is no secondary labels for the objects. Therefore, no secondary label index is signaled.

In some embodiments, the secondary label present flag is signaled for each object and thus encoder can separately decide whether to signal the secondary label for each object.

FIG. 11C show another exemplary portion of syntax structure 1100C of combined label list, according to some embodiments of the present disclosure. The syntax structure 1100C can be used in method 1100A. Syntax structure 1100C only shows the changes made to syntax structure 1100B. The changes from the syntax structure 1100B are shown in block 1110C-1130C.

Referring to FIG. 11C, syntax element or_object_secondary_label_present_flag[or_object_idx[i]] being equal to 1 indicates that the or_object_secondray_label_idx for the or_object_idx[i]-th object may be present. or_object_secondary_label_present_flag being equal to 0 indicates or_object_secondary_label_idx for the or_object_idx[i]-th object is not present. It is a requirement of bitstream conformance that the value of or_object_secondary_label_present_flag is the same for all object_representation( ) syntax structures within a CLVS.

As shown in 1110C, compared with FIG. 11B, syntax element or_object_secondary_label_present_flag 1130B is not signaled in label controlling flag portion. Instead, syntax element or_object_secondary_label_prsent_flag[or_object_idx[i]] 1120C is signaled for each object in object label index portion, and syntax element or_object_secondary_label_idx[or_object_idx[i]] 1130C is signaled for each object based on the determination of the or_object_secondary_label_prsent_flag[or_object_idx[i]] 1120C.

Additionally, in the combined-label-list embodiments as shown in FIGS. 11B and 11C, syntax elements or_object_label_update_allow_flag and or_object_label_update_flag are shared by primary label and secondary label if both primary label and secondary label are present. But in other embodiments of this disclosure, there are separated flags for primary label and secondary label. For example, or_object_primary_label_update_allow_flag and or_object_primary_label_update_flag are for primary label and or_object_secondary_label_update_allow_flag and or_object_secondary_label_update_flag are for secondary label.

In the current AR SEI message, the detected or tracked object is represented by a bounding box. The position information of the object can be described by the bounding box while the shape information of the object cannot be represented by the bounding box. To applications that use segmentation to facilitate functionalities such as virtual background, more accurate description of the object shape information is needed. And performing object segmentation is power consuming which is a big burden to mobile device. Once object segmentation is performed, it may be desirable to carry such information in the video bitstream as side information. The syntax of the current AR SEI message as shown in FIG. 5 does not carry such information.

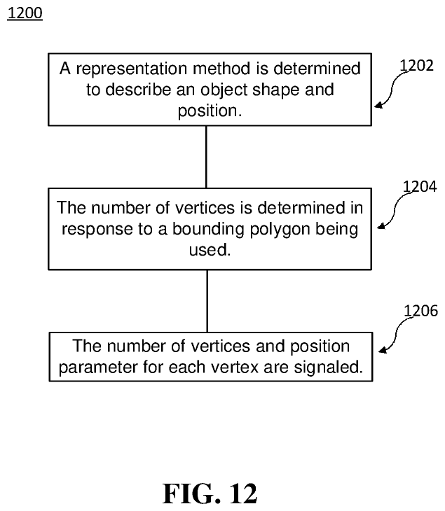

To describe the object shape information more accurately, besides the bounding box, a bounding polygon in the form of a set of vertices is proposed according to some embodiments of the present disclosure. FIG. 12 illustrates a flowchart of an exemplary method 1200 for video processing using object representation SEI message, according to some embodiments of the present disclosure. Method 1200 can be performed by an encoder (e.g., by process 200A of FIG. 2A or 200B of FIG. 2B) or performed by one or more software or hardware components of an apparatus (e.g., apparatus 400 of FIG. 4). For example, one or more processors (e.g., processor 402 of FIG. 4) can perform method 1200. In some embodiments, method 1200 can be implemented by a computer program product, embodied in a computer-readable medium, including computer-executable instructions, such as program code, executed by computers (e.g., apparatus 400 of FIG. 4). Referring to FIG. 12, method 1200 may include the following steps 1202-1206.

At step 1202, a representation method is determined to describe an object shape and position. The representation method can be a bounding box or a bounding polygon. And a flag can be signaled to indicate whether bounding box or bounding polygon is used to describe the object shape and position. In some embodiments, the representation method can be a bounding circle, and an index can be signaled to indicate which representation method is used.

At step 1204, the number of vertices is determined in response to the bounding polygon being used. The number of vertices is not fixed, and the encoder can determine the number of vertices based on the object shape and the accuracy required for description depending on the application. For an object with a simple shape (such as triangle or rectangle) or for an application that doesn't request accurate shape information, a small number of vertices is determined to save the bits, and for an object with complex shape or for an application that requests accurate representation of the object shape (for example a video conferencing application that uses boundary information to provide virtual background functionality), a large number of vertices is determined to represent the object boundary.

At step 1206, the number of vertices and position parameter for each vertex are signaled. A boundary polygon can be determined based on the number of vertices and the position parameters. In some embodiments, the position parameters include coordinates of a vertex.

The proposed bounding box and bounding polygon also use the persistence mechanism, so that only the bounding information for moving object is re-signaled. The minimum number of bounding polygon vertices is set to 3.

Referring back to FIG. 7A, as shown in object position parameter portion 743, syntax element or_object_region_flag 7431 is signaled to indicate using bounding box or bounding polygon. If a bounding box is used, parameters for bounding box are signaled to describe the position of an object. If a bounding polygon is used, the number of vertices of the bounding polygon is signaled, and coordinates for each vertex are further signaled.

In some embodiments, a flag or_object_region_flag[or_object_idx[i]] is signaled per object, so that different objects can use different ways to be represented, either using bounding box or using bounding polygon. In some applications, all the tracked objects in the picture or the entire sequence may use the same method of object representation. Thus, signaling a flag for each object may be inefficient. Therefore, switching between bounding box and bounding polygon is provided according to some embodiments of the present disclosure, in which a flag or_object_region_flag is signaled for all the objects updated in the current OR SEI message, and this flag is constraint to have the same value in the whole CLVS. Thus, all the objects in a CLVS should have same representation way.

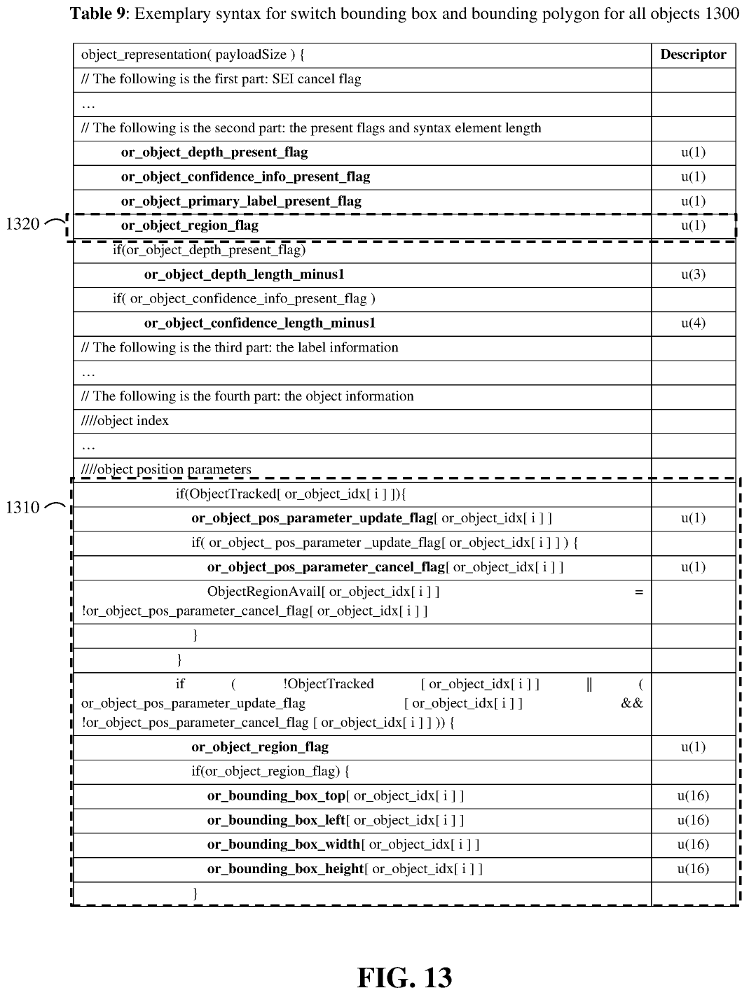

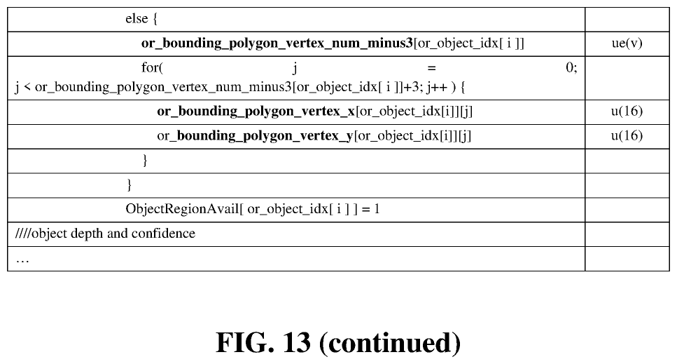

FIG. 13 shows an exemplary portion of syntax structure 1300 of applying same representation method for all objects, according to some embodiments of the present disclosure. Syntax structure 1300 only shows the changes made to syntax structure 800B. The main changes from the syntax structure 800B are shown block 1310.

Referring to FIG. 13, syntax element or_object_region_flag 1320 being equal to 1 specifies or_bounding_box_top[or_object_idx[i]], or_bounding_box_left[or_object_idx[i]], or_bounding_box_width[or_object_idx[i]], or_bounding_box_height[or_object_idx[i]], for i in the range of 0 to or_num_object_updates-1, are present, or_bounding_polygon_vertex_num_minus3[or_object_idx[i]], or_bounding_polygon_vertex_x[or_object_idx[i]][j], or_bounding_polygon_vertex_y[or_object_idx[i]][j], for i in the range of 0 to or_num_object_updates-1, are not present. Syntax element or_object_region_flag 1320 being equal to 0 specifies that or_bounding_box_top[or_object_idx[i]], or_bounding_box_left[or_object_idx[i]], or_bounding_box_width[or_object_idx[i]], or_bounding_box_height[or_object_idx[i]], for i in the range of 0 to or_num_object_updates-1, are not present, or_bounding_polygon_vertex_num_minus3[or_object_idx[i]], or_bounding_polygon_vertex_x[or_object_idx[i]][j], or_bounding_polygon_vertex_y[or_object_idx[i]][j], for i in the range of 0 to or_num_object_updates-1, are present.

Syntax element or_object_region_flag 1320 is signaled for indicating the representation method for objects. As shown in block 1310, when syntax element or_object_region_flag 1320 is equal to 1, parameters for bounding box method are signaled. Otherwise, parameters for bounding polygon are signaled. In this way, the same representation method is applied for all the objects. There is no need to determine the representation method for each object, therefore, the efficiency is improved.

In some embodiments, the absolute values of vertex coordinates are signaled. For a polygon with a lot of vertices, it is a big signaling overhead. As an alternative signaling method proposed in the present disclosure, the different values of coordinates of two connected vertex are signaled to save the signaling bits.

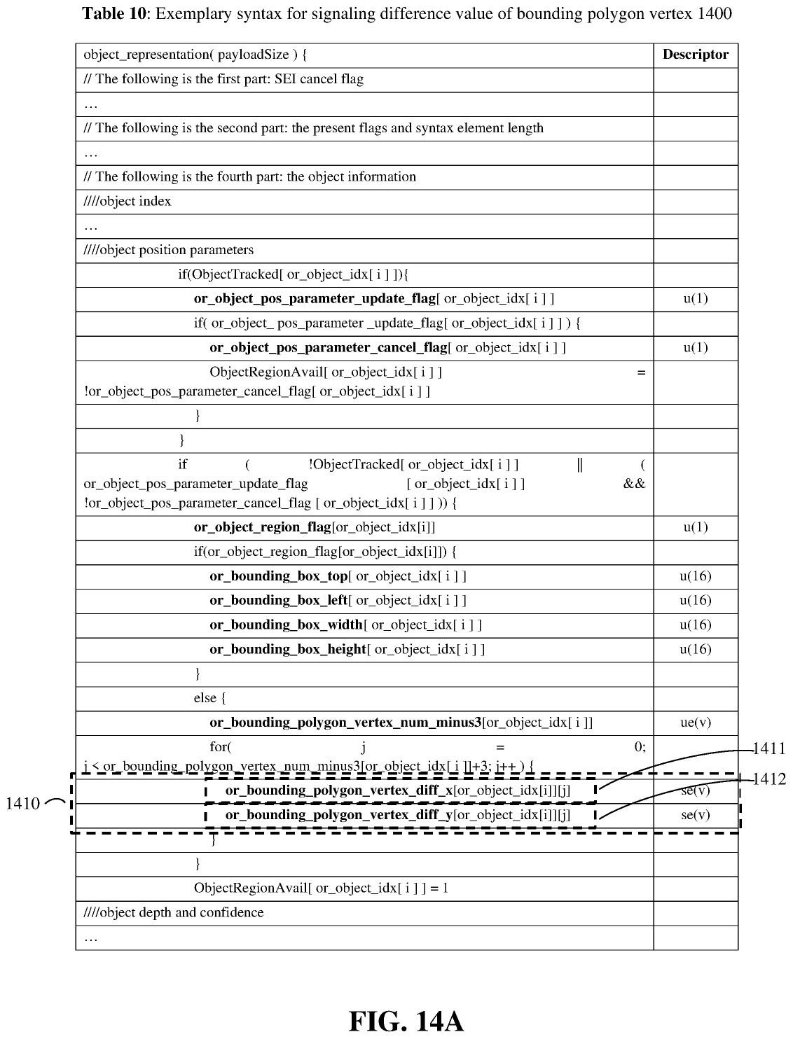

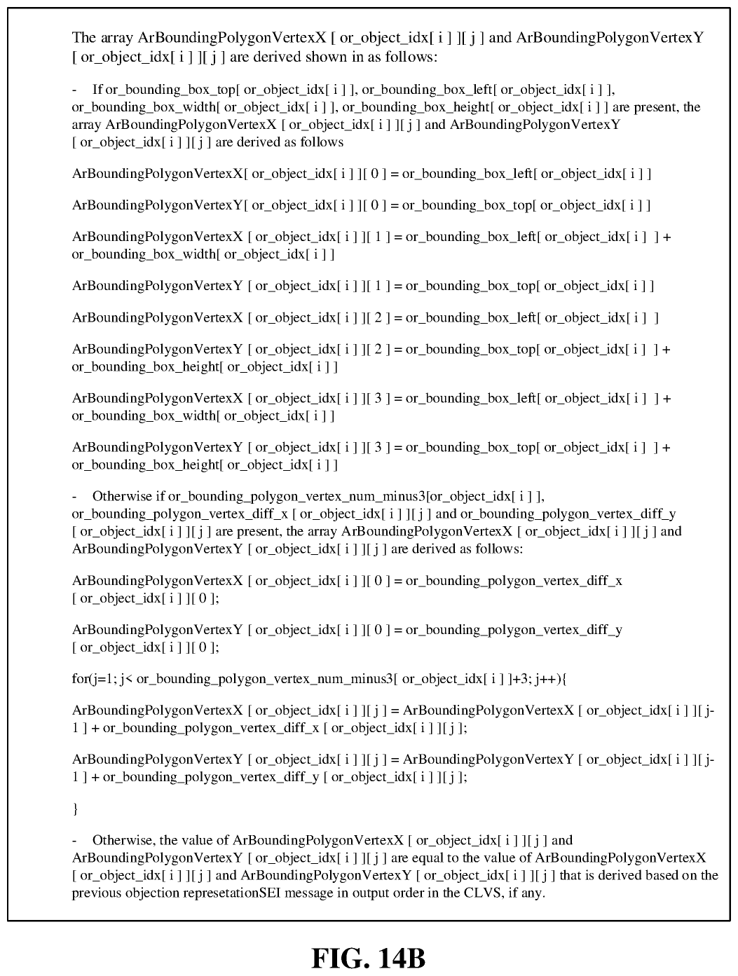

FIG. 14A shows an exemplary portion of syntax structure 1400 of signaling different value of coordinates of two connected vertex, according to some embodiments of the present disclosure. Syntax structure 1400 only shows the changes made to syntax structure 1300. The changes from the syntax structure 1300 are shown in block 1410.

Referring to FIG. 14A, syntax elements or_bounding_polygon_vertex_diff_x [or_object_idx[i]][j] 1411, or_bounding_polygon_vertex_diff_y[or_object_idx[i]][j] 1412 specify the coordinate differences of the j-th vertex and (j−1)-th vertex of bounding polygon associated with the or_object_idx[i]-th object in the cropped decoded picture, relative to the conformance cropping window specified by the active SPS when j is larger than 0; or_bounding_polygon_vertex_diff_x[or_object_idx[i]][0], or_bounding_polygon_vertex_diff_[or_object_idx[i]][0] specify the coordinates of the 0-th vertex of bounding polygon associated with the or_object_idx[i]-th object in the cropped decoded picture, relative to the conformance cropping window specified by the active SPS.

FIG. 14B shows an example pseudocode including derivation for array ArBoundingPolygonVertexX [or_object_idx[i]][j] and ArBoundingPolygonVertexY [or_object_idx[i]][j], according to some embodiments of the present disclosure.

The array ArBoundingPolygonVertexX [or_object_idx[i]][j] and ArBoundingPolygonVertexY [or_object_idx[i]][j] are derived as shown in FIG. 14B.

Let croppedWidth and croppedHeight be the width and height, respectively, of the cropped decoded picture in units of luma samples.

The value of ArBoundingPolygonVertexX [or_object_idx[i]][j] is in the range of 0 to croppedWidth/SubWidthC-1, inclusive.

The value of ArBoundingPolygonVertexY [or_object_idx[i]][j] is in the range of 0 to croppedHeight/SubHeightC-1, inclusive.

The values of ArBoundingPolygonVertexX [or_object_idx[i]][j] and ArBoundingPolygonVertexY [or_object_idx[i]][j] persist in output order within the CLVS for each value of or_object_idx[i].

As shown in block 1410, the syntax elements or_bounding_polygon_vertex_diff_x [or_object_idx[i]][j] 1411, or_bounding_polygon_vertex_diff_y [or_object_idx[i]][j] 1412 are signaled instead of signaling or_bounding_polygon_vertex_x [or_object_idx[i]][j] and or_bounding_polygon_vertex_y [or_object_idx[i]][j]. Therefore, signaling the different values of coordinates of two connected vertex can save the signaling bits.

Considering the fact that bounding box is a special case of the bounding polygon. In some embodiments, only bounding polygon is used to represent object. Thus, the syntax can be simplified in the following embodiment regarding removal of bounding box.

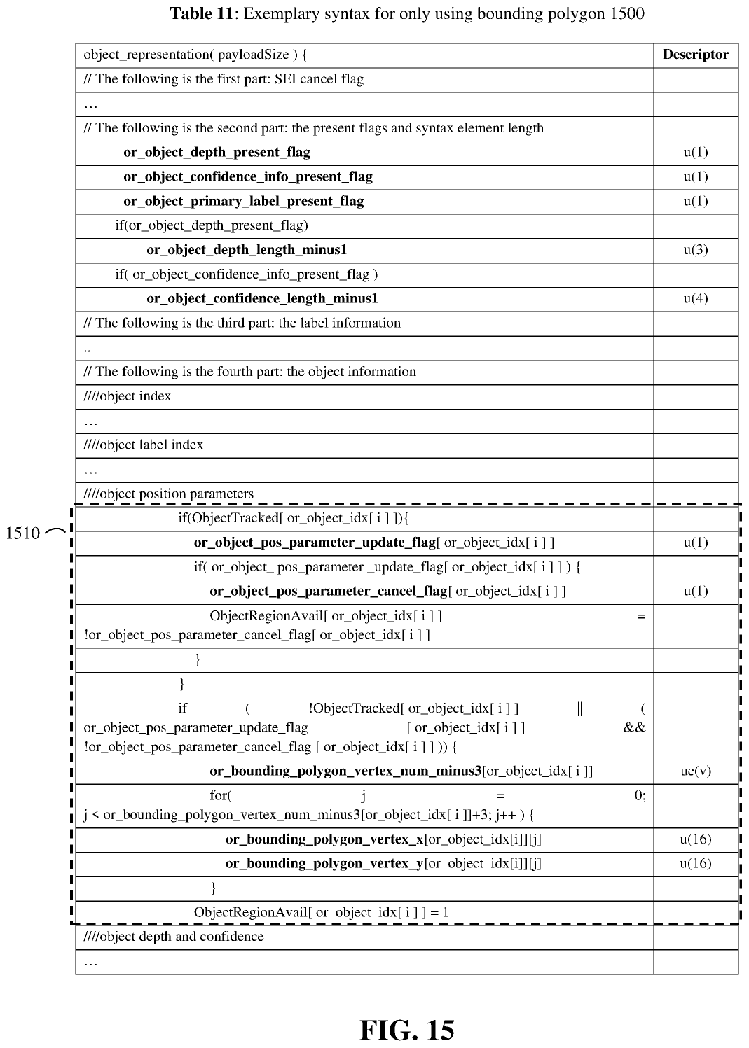

FIG. 15 shows an exemplary portion of syntax structure 1500 of only using bounding polygon, according to some embodiments of the present disclosure. Syntax structure 1500 only shows the changes made to syntax structure 800B. The changes from the syntax structure 800B are shown in block 1510.

Referring to FIG. 15, since only bounding polygon is used for all the objects, syntax elements or_objet_region_flag, or_bounding_box_top[ ], or_bounding_box_left [ ] or_bounding_box_width[ ]] or_bounding_box_height[ ] are not signaled in this embodiment. That is, referring back to FIG. 12, the step 1202 can be skipped. Therefore, the syntax is further simplified.

In the current AR SEI message, the syntax element ar_partial_object_flag 530 (as shown in FIG. 5) indicates whether the object represented by the bounding box is partially visible or fully visible. However, in the case that the object is partially visible, there is no parameters to tell the decoder which part is visible and which part is occluded. So syntax element ar_partial_object_flag 530 itself doesn't provide much information to the decoder to figure out the visible areas and invisible areas of an object. Instead, object depth information may provide a better mechanism to describe the relative positions of different objects in the picture in terms of their distance to the camera. Such information can be directly used to derive which parts of which objects are occluded or not.

In some embodiments, the depth of the object is proposed to be signaled, to indicate the relative positions of the objects (e.g. whether parts of an object is visible, partially visible, or completely occluded). So when two bounding boxes or bounding polygons overlap with each other, the decoder can easily know which parts of the objects are visible according to the depth of the object. For example, syntax element or_object_depth[or_object_idx[i]] 7441 is signaled as shown in FIG. 7A.

In some embodiments, the variable length code u(v) is used to code the depth of the object. And the length of code is decided by encoder and signaled in the bitstream. It does give the encoder the flexibility. So for the case where there are many objects with different depths, the encoder may use more bits to fully represent all the levels of the depth and for the case where there are not many objects with different depths, the encoder can use fewer bits to save the signaling overhead.

However, in the common use cases, usually there are not many different depths associated with objects. Even if fixed length codes is used to code the depth, it will not take a lot of bits. Thus, as an alternative coding way, in some embodiments, a fixed length code is used for depth.

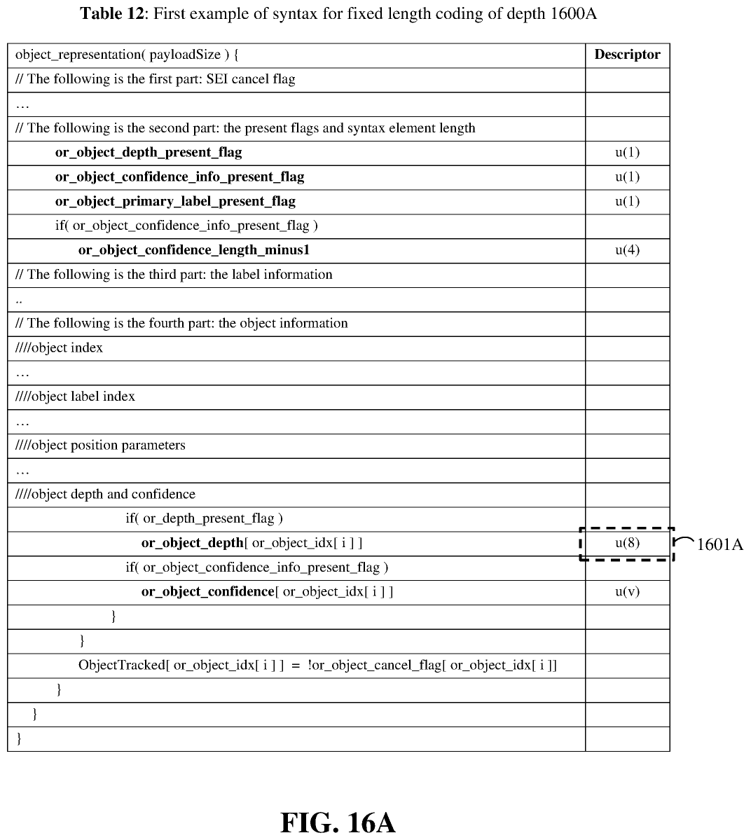

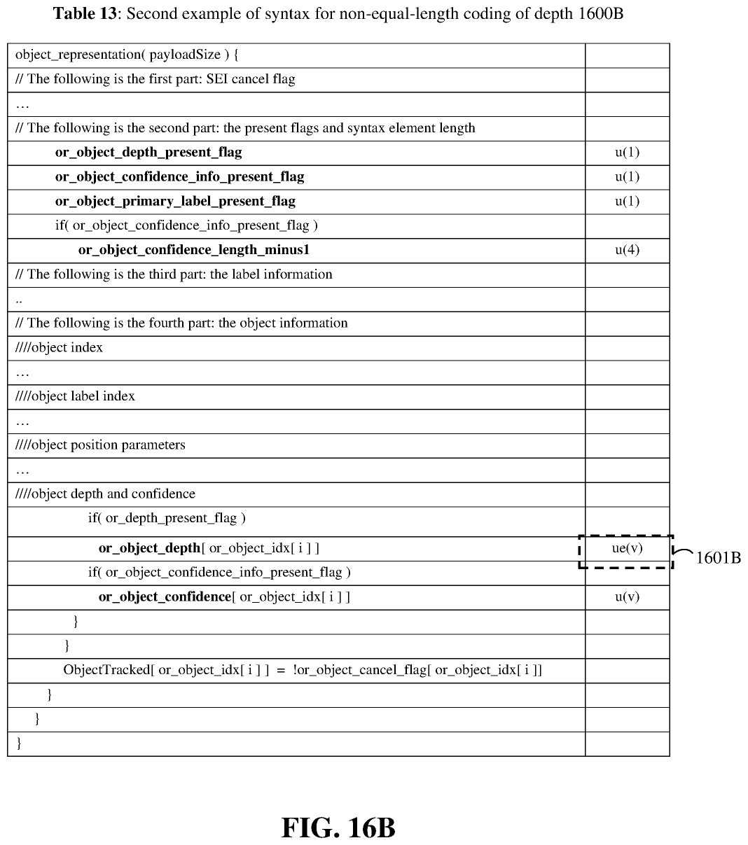

FIG. 16A shows an exemplary portion of syntax structure 1600A of using a fixed length code, according to some embodiments of the present disclosure. Syntax structure 1600A only shows the changes made to syntax structure 700.

As an example shown in FIG. 16A the depth of each object is coded with a 8-bit code u(8) 1601A, so the code length supports up to 256 different depths. However, this embodiment doesn't restrict the code length of depth to be 8. Other length can also be used and the precision of the depth is dependent on the code length of depth.

For some cases, both u(v) code and u(8) code which are used to code depth are equal length codes. Therefore, the code lengths of depths with different values are the same, even for an object not being overlapped.

FIG. 16B shows another exemplary portion of syntax structure 1600B of using a variable length code, according to some embodiments of the present disclosure. Syntax structure 1600B only shows the changes made to syntax structure 700.

As shown in FIG. 16B, variable length coding such as ue(v) 1601B is used to code depth. Since the depths are coded with unsigned integer exponential Columbus coding, the code lengths of depths with different values are different. With ue(v) coding, a shorter code is assigned to a smaller value and a longer code is assigned to a bigger value. Therefore, the coding for length of the object depth can be more flexible.

It is appreciated that in some embodiments, the methods 600, 800A, 1000A (or 1100A), and 1200 can be performed in any combination. In some embodiments, the syntax structures 800B, 900A (or 900B), 1000B, 1100B (or 1100C), 1300, 1400, 1500 and 1600A (or 1600B) can be applied in any combination by modifying the syntax structure 700.

It is appreciated that while the present disclosure refers to various syntax elements providing inferences based on the value being equal to 0 or 1, the values can be configured in any way (e.g., 1 or 0) for providing the appropriate inference.

The embodiments may further be described using the following clauses:

1. A method for indicating an object in a picture with a plurality of parameters, comprising:
signaling a first list of labels; and
signaling a first index, to the first list of labels, of a first label associated with the object.

2. The method of clause 1, further comprising:
signaling a second index, to the first list of labels, of a second label associated with the object, wherein the second index is different from the first index.

3. The method of clause 1, further comprising:
signaling a second list of labels, wherein the first and second label lists do not include a same label; and
signaling a second index, to the second list of labels, of a second label associated with the object.

4. The method of clause 1, further comprising:
signaling a second list of labels corresponding to labels in the first list of labels, respectively; and
signaling a second index, to the second list of labels, of a second label associated with the object.

5. The method of any one of clauses 1 to 4, further comprising:
signaling a label in the first list of labels without determining whether the label is to be updated.

6. The method of clause 5, further comprising:
in response to a new object in the picture, signaling the first index of the first label associated with the object without determining whether to cancel persistence of the parameters.

7. The method of clause 5 or 6, further comprising:
in response to a new object in the picture, signaling the first index of the first label associated with the object without determining whether to update the first label associated with the object.

8. The method of any one of clauses 1 to 7, further comprising:
signaling a depth of the object to indicate a relative position of objects.

9. The method of any one of clauses 1 to 8, further comprising:
signaling object position parameters; and
signaling the first index of the first label associated with the object based on the object position parameters.

10. The method of any one of clauses 1 to 9, further comprising:
signaling a polygon to indicate a shape and a position of the object in the picture.

11. A method for indicating an object in a picture with a plurality of parameters, comprising:
signaling a polygon to indicate a shape and a position of the object in the picture.

12. The method of clause 11, wherein signaling the polygon to indicate the shape and the position of the object in the picture comprises:
signaling a number of vertices of the polygon; and
signaling a coordinator of each vertex of the polygon.

13. The method of clause 11, wherein prior to signaling the polygon to indicate the shape and the position of the object in the picture, the method further comprises:
signaling a flag indicating whether to indicate the object with a polygon or with a rectangle; and
in response to the flag indicating to indicate the object with a rectangle, signaling coordinators of 4 vertices of the rectangle.

14. The method of any one of clauses 11 to 13, further comprising:
signaling a label without determining whether the label is to be updated.

15. The method of clause 14, further comprising:
in response to a new object in the picture, signaling label information associated with the object without determining whether to cancel persistence of the parameters.

16. The method of any one of clauses 11 to 15, further comprising:
signaling a depth of the object to indicate a relative position of objects.

17. The method of any one of clauses 11 to 16, further comprising:
signaling object position parameters; and
signaling object label information based on the object position parameters.

18. A method for indicating an object in a picture with a plurality of parameters, comprising:
signaling a depth of the object to indicate a relative position of objects.

19. The method of clause 18, wherein a code length of the depth of the object is fixed.

20. The method of clause 18, wherein the depth of the object is coded with an unsigned integer exponential Columbus code.

21. A method for determining an object in a picture, comprising:
decoding a message from a bitstream comprising:
   decoding a first list of labels; and
   decoding a first index, to the first list of labels, of a first label associated with the object; and
determining the object based on the message.

22. The method of clause 21, wherein decoding the message from the bitstream further comprises:
decoding a second index, to the first list of labels, of a second label associated with the object, wherein the second index is different from the first index.

23. The method of clause 21, wherein decoding the message from the bitstream further comprises:
decoding a second list of labels, wherein the first and second label lists do not include a same label; and
decoding a second index, to the second list of labels, of a second label associated with the object.

24. The method of clause 21, wherein decoding the message from a bitstream further comprises:
decoding a second list of labels corresponding to labels in the first list of labels, respectively; and
decoding a second index, to the second list of labels, of a second label associated with the object.

25. The method of any one of clauses 21 to 24, wherein decoding the message from the bitstream further comprises:
decoding a label in the first list of labels without determining whether the first label is to be updated.

26. The method of clause 25, wherein decoding the message from the bitstream further comprises:
in response to a new object in the picture, decoding the first index of the first label associated with the object without determining whether to cancel persistence of the parameters.

27. The method of clause 25 or 26, wherein decoding the message from the bitstream further comprises:
in response to a new object in the picture, decoding the first index of the first label associated with the object without determining whether to update the first label associated with the object.

28. The method of any one of clauses 21 to 27, wherein decoding the message from the bitstream further comprises:
decoding a depth of the object to indicate a relative position of objects.

29. The method of any one of clauses 21 to 28, wherein decoding the message from the bitstream further comprises:
decoding object position parameters; and
decoding the first index of the first label associated with the object based on the object position parameters.

30. The method of any one of clauses 21 to 29, wherein decoding the message from the bitstream further comprises:
decoding a polygon to indicate a shape and a position of the object in the picture.

31. A method for determining an object in a picture, comprises:
decoding a message from a bitstream comprising:
   decoding a polygon indicating a shape and a position of the object in the picture; and
determining the object based on the message.

32. The method of clause 31, wherein decoding the polygon indicating the shape and the position of the object in the picture further comprises:
decoding a number of vertices of the polygon; and
decoding a coordinator of each vertex of the polygon.

33. The method of clause 31, wherein prior to decoding the polygon indicating the shape and the position of the object in the picture, decoding a message from a bitstream further comprises:
decoding a flag indicating whether the object is indicated by a polygon or by a rectangle; and
in response to the flag indicating the object is indicated by a rectangle, decoding coordinators of 4 vertices of the rectangle.

34. The method of any one of clauses 31 to 33, wherein decoding the message from the bitstream further comprises:
decoding a label without determining whether the label is to be updated.

35. The method of clause 34, wherein decoding the message from the bitstream further comprises:
in response to a new object in the picture, decoding label information associated with the object without determining whether to cancel persistence of the parameters.

36. The method of any one of clauses 31 to 35, wherein decoding the message from the bitstream further comprises:
decoding a depth of the object to indicate a relative position of objects.

37. The method of any one of clauses 31 to 36, wherein decoding the message from the bitstream further comprises:
decoding object position parameters; and
decoding object label information based on the object position parameters.

38. A method for determining an object in a picture, comprising:
decoding a message from a bitstream comprising:
   decoding a depth of the object to indicate a relative position of objects; and
determining the object in the picture based on the message.

39. The method of clause 38, wherein a code length of the depth of the object is fixed.

40. The method of clause 38, wherein the depth of the object is coded with an unsigned integer exponential Columbus code.

41. An apparatus for indicating an object in a picture, the apparatus comprising:

a memory figured to store instructions; and

one or more processors configured to execute the instructions to cause the apparatus to perform:
signaling a first list of labels; and
signaling a first index, to the first list of labels, of a first label associated with the object.

42. The apparatus of clause 441, wherein the one or more processors are further configured to execute the instructions to cause the apparatus to perform:
signaling a second index, to the first list of labels, of a second label associated with the object, wherein the second index is different from the first index.

43. The apparatus of clause 41, wherein the one or more processors are further configured to execute the instructions to cause the apparatus to perform:
signaling a second list of labels, wherein the first and second label lists do not include a same label; and
signaling a second index, to the second list of labels, of a second label associated with the object.

44. The apparatus of clause 41, wherein the one or more processors are further configured to execute the instructions to cause the apparatus to perform:
signaling a second list of labels corresponding to labels in the first list of labels, respectively; and
signaling a second index, to the second list of labels, of a second label associated with the object.

45. The apparatus of clause 41, wherein the one or more processors are further configured to execute the instructions to cause the apparatus to perform:
signaling a label in the first list of labels without determining whether the label is to be updated.

46. The apparatus of clause 45, wherein the one or more processors are further configured to execute the instructions to cause the apparatus to perform:
in response to a new object in the picture, signaling the first index of the first label associated with the object without determining whether to cancel persistence of the parameters.

47. The apparatus of clause 45, wherein the one or more processors are further configured to execute the instructions to cause the apparatus to perform:
in response to a new object in the picture, signaling the first index of the first label associated with the object without determining whether to update the first label associated with the object.

48. An apparatus for indicating an object in a picture, the apparatus comprising:

a memory figured to store instructions; and

one or more processors configured to execute the instructions to cause the apparatus to perform:
signaling a polygon to indicate a shape and a position of the object in the picture.

49. The apparatus of clause 48, wherein signaling the polygon to represent the shape and the position of the object in the picture comprises:
signaling a number of vertices of the polygon; and
signaling a coordinator of each vertex of the polygon.

50. The apparatus of clause 48, wherein prior to signaling the polygon to indicate the shape and the position of the object in the picture, the one or more processors are further configured to execute the instructions to cause the apparatus to perform:
signaling a flag indicating whether to indicate the object with a polygon or with a rectangle; and
in response to the flag indicating to indicate the object with a rectangle, signaling coordinators of 4 vertices of the rectangle.

51. An apparatus for indicating an object in a picture, the apparatus comprising:

a memory figured to store instructions; and

one or more processors configured to execute the instructions to cause the apparatus to perform:
signaling a depth of the object to indicate a relative position of objects.

52. The apparatus of clause 51, wherein a code length of the depth of the object is fixed.

53. The apparatus of clause 51, wherein the depth of object is coded with an unsigned integer exponential Columbus code.

54. An apparatus for determining an object in a picture, the apparatus comprising:

a memory figured to store instructions; and

one or more processors configured to execute the instructions to cause the apparatus to perform:

decoding a message from a bitstream comprising:
decoding a first list of labels; and
decoding a first index, to the first list of labels, of a first label associated with the object; and

determining the object based on the message.

55. The apparatus of clause 54, wherein the one or more processors are further configured to execute the instructions to cause the apparatus to perform:
decoding a second index, to the first list of labels, of a second label associated with the object, wherein the second index is different from the first index.

56. The apparatus of clause 54, the one or more processors are further configured to execute the instructions to cause the apparatus to perform:
decoding a second list of labels, wherein the first and second label lists do not include a same label; and
decoding a second index, to the second list of labels, of a second label associated with the object.

57. The apparatus of clause 54, the one or more processors are further configured to execute the instructions to cause the apparatus to perform:
decoding a second list of labels corresponding to labels in the first list of labels, respectively; and
decoding a second index, to the second list of labels, of a second label associated with the object.

58. The apparatus of clause 54, the one or more processors are further configured to execute the instructions to cause the apparatus to perform:
decoding a label in the first list of labels without determining whether the first label is to be updated.

59. The apparatus of clause 58, the one or more processors are further configured to execute the instructions to cause the apparatus to perform:
in response to a new object in the picture, decoding the first index of the first label associated with the object without determining whether to cancel persistence of the parameters.

60. The apparatus of clause 58, the one or more processors are further configured to execute the instructions to cause the apparatus to perform:
in response to a new object in the picture, decoding the first index of the first label associated with the object without determining whether to update the first label associated with the object.

61. An apparatus for determining an object in a picture, the apparatus comprising:

a memory figured to store instructions; and

one or more processors configured to execute the instructions to cause the apparatus to perform:
decoding a message from a bitstream comprising:
   decoding a polygon indicating a shape and a position of the object in the picture; and
determining the object based on the message.

62. The apparatus of clause 61, the one or more processors are further configured to execute the instructions to cause the apparatus to perform:
decoding a number of vertices of the polygon; and
decoding a coordinator of each vertex of the polygon.

63. The apparatus of clause 61, wherein prior to decoding the polygon indicating the shape and the position of the object in the picture, the one or more processors are further configured to execute the instructions to cause the apparatus to perform:
decoding a flag indicating whether the object is indicated by a polygon or by a rectangle; and
in response to the flag indicating the object is indicated by a rectangle, decoding coordinators of 4 vertices of the rectangle.

64. The apparatus of clause 61, the one or more processors are further configured to execute the instructions to cause the apparatus to perform:
decoding a label without determining whether the label is to be updated.

65. The apparatus of clause 64, the one or more processors are further configured to execute the instructions to cause the apparatus to perform:
in response to a new object in the picture, decoding label information associated with the object without determining whether to cancel persistence of the parameters.

66. The apparatus of clause 61, the one or more processors are further configured to execute the instructions to cause the apparatus to perform:
decoding object position parameters; and
decoding object label information based on the object position parameters.

67. An apparatus for determining an object in a picture, the apparatus comprising:

a memory figured to store instructions; and

one or more processors configured to execute the instructions to cause the apparatus to perform:
decoding a message from a bitstream comprising:
   decoding a depth of the object to indicate a relative position of objects; and
determining the object in the picture based on the message.

68. A non-transitory computer readable medium that stores a set of instructions that is executable by one or more processors of an apparatus to cause the apparatus to initiate a method for indicating an object in a picture, the method comprising:
signaling a first list of labels; and
signaling a first index, to the first list of labels, of a first label associated with the object.

69. The non-transitory computer readable medium of clause 68, wherein the set of instructions that is executable by one or more processors of an apparatus to cause the apparatus to further perform:
signaling a second index, to the first list of labels, of a second label associated with the object, wherein the second index is different from the first index.

70. The non-transitory computer readable medium of clause 68, wherein the set of instructions that is executable by one or more processors of an apparatus to cause the apparatus to further perform:

signaling a second list of labels, wherein the first and second label lists do not include a same label; and

signaling a second index, to the second list of labels, of a second label associated with the object.

71. The non-transitory computer readable medium of clause 68, wherein the set of instructions that is executable by one or more processors of an apparatus to cause the apparatus to further perform:

signaling a second list of labels corresponding to labels in the first list of labels, respectively; and

signaling a second index, to the second list of labels, of a second label associated with the object.

72. The non-transitory computer readable medium of clause 68, wherein the set of instructions that is executable by one or more processors of an apparatus to cause the apparatus to further perform:

signaling a label in the first list of labels without determining whether the label is to be updated.

73. The non-transitory computer readable medium of clause 72, wherein the set of instructions that is executable by one or more processors of an apparatus to cause the apparatus to further perform:

in response to a new object in the picture, signaling the first index of the first label associated with the object without determining whether to cancel persistence of the parameters.

74. The non-transitory computer readable medium of clause 73, wherein the set of instructions that is executable by one or more processors of an apparatus to cause the apparatus to further perform:
in response to a new object in the picture, signaling the first index of the first label associated with the object without determining whether to update the first label associated with the object.

75. A non-transitory computer readable medium that stores a set of instructions that is executable by one or more processors of an apparatus to cause the apparatus to initiate a method for indicating an object in a picture, the method comprising:

signaling a polygon to indicate a shape and a position of the object in the picture.

76. The non-transitory computer readable medium of clause 75, wherein the set of instructions that is executable by one or more processors of an apparatus to cause the apparatus to further perform:
signaling a number of vertices of the polygon; and
signaling a coordinator of each vertex of the polygon.

77. The non-transitory computer readable medium of clause 75, wherein prior to signaling the polygon to indicate the shape and the position of the object in the picture, the set of instructions that is executable by one or more processors of an apparatus to cause the apparatus to further perform:
signaling a flag indicating whether to indicate the object with a polygon or with a rectangle; and
in response to the flag indicating to indicate the object with a rectangle, signaling coordinators of 4 vertices of the rectangle.

78. A non-transitory computer readable medium that stores a set of instructions that is executable by one or more processors of an apparatus to cause the apparatus to initiate a method for indicating an object in a picture, the method comprising:
signaling a depth of the object to indicate a relative position of objects.

79. The non-transitory computer readable medium of clause 78, wherein a code length of the depth of the object is fixed.

80. The non-transitory computer readable medium of clause 78, wherein the depth of the object is coded with un unsigned integer exponential Columbus code.

81. A non-transitory computer readable medium that stores a set of instructions that is executable by one or more processors of an apparatus to cause the apparatus to initiate a method for determining an object in a picture, the method comprising:

decoding a message from a bitstream comprising:
decoding a first list of labels; and
decoding a first index, to the first list of labels, of a first label associated with the object; and
determining the object based on the message.

82. The non-transitory computer readable medium of clause 81, wherein the set of instructions that is executable by one or more processors of an apparatus to cause the apparatus to further perform:
decoding a second index, to the first list of labels, of a second label associated with the object, wherein the second index is different from the first index.

83. The non-transitory computer readable medium of clause 81, wherein the set of instructions that is executable by one or more processors of an apparatus to cause the apparatus to further perform:
decoding a second list of labels, wherein the first and second label lists do not include a same label; and
decoding a second index, to the second list of labels, of a second label associated with the object.

84. The non-transitory computer readable medium of clause 81, wherein the set of instructions that is executable by one or more processors of an apparatus to cause the apparatus to further perform:
decoding a second list of labels corresponding to labels in the first list of labels, respectively; and
decoding a second index, to the second list of labels, of a second label associated with the object.

85. The non-transitory computer readable medium of clause 81, wherein the set of instructions that is executable by one or more processors of an apparatus to cause the apparatus to further perform:
decoding a label in the first list of labels without determining whether the first label is to be updated.

86. The non-transitory computer readable medium of clause 85, wherein the set of instructions that is executable by one or more processors of an apparatus to cause the apparatus to further perform:
in response to a new object in the picture, decoding the first index of the first label associated with the object without determining whether to cancel persistence of the parameters.

87. The non-transitory computer readable medium of clause 86, wherein the set of instructions that is executable by one or more processors of an apparatus to cause the apparatus to further perform:
in response to a new object in the picture, decoding the first index of the first label associated with the object without determining whether to update the first label associated with the object.

88. A non-transitory computer readable medium that stores a set of instructions that is executable by one or more processors of an apparatus to cause the apparatus to initiate a method for determining an object in a picture, the method comprising:
decoding a message from a bitstream comprising:
   decoding a polygon indicating a shape and a position of the object in the picture; and
determining the object based on the message.

89. The non-transitory computer readable medium of clause 88, wherein the set of instructions that is executable by one or more processors of an apparatus to cause the apparatus to further perform:
decoding a number of vertices of the polygon; and
decoding a coordinator of each vertex of the polygon.

90. The non-transitory computer readable medium of clause 88, wherein prior to decoding the polygon indicating the shape and the position of the object in the picture, the set of instructions that is executable by one or more processors of an apparatus to cause the apparatus to further perform:
decoding a flag indicating whether the object is indicated by a polygon or by a rectangle; and
in response to the flag indicating the object is indicated by a rectangle, decoding coordinators of 4 vertices of the rectangle.

91. The non-transitory computer readable medium of clause 88, wherein the set of instructions that is executable by one or more processors of an apparatus to cause the apparatus to further perform:
decoding a label without determining whether the label is to be updated.

92. The non-transitory computer readable medium of clause 91, wherein the set of instructions that is executable by one or more processors of an apparatus to cause the apparatus to further perform:
in response to a new object in the picture, decoding label information associated with the object without determining whether to cancel persistence of the parameters.

93. The non-transitory computer readable medium of clause 88, wherein the set of instructions that is executable by one or more processors of an apparatus to cause the apparatus to further perform:
decoding object position parameters; and
decoding object label information based on the object position parameters.

94. A non-transitory computer readable medium that stores a set of instructions that is executable by one or more processors of an apparatus to cause the apparatus to initiate a method for determining an object in a picture, the method comprising:
decoding a message from a bitstream comprising:
   decoding a depth of the object to indicate a relative position of objects; and
determining the object in the picture based on the message.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for determining an object in a picture, comprising:
decoding a message from a bitstream comprising:
decoding a first list of labels; and
decoding a first index, to the first list of labels, of a first label associated with the object; and
determining the object based on the message.

2. The method of claim 1, wherein decoding the message from the bitstream further comprises:
decoding a second index, to the first list of labels, of a second label associated with the object, wherein the second index is different from the first index.

3. The method of claim 1, wherein decoding the message from the bitstream further comprises:
decoding a second list of labels, wherein the first and second label lists do not include a same label; and
decoding a second index, to the second list of labels, of a second label associated with the object.

4. The method of claim 1, wherein decoding the message from a bitstream further comprises:
decoding a second list of labels corresponding to labels in the first list of labels, respectively; and
decoding a second index, to the second list of labels, of a second label associated with the object.

5. The method of claim 1, wherein decoding the message from the bitstream further comprises:
decoding a depth of the object to indicate a relative position of objects.

6. The method of claim 1, wherein decoding the message from the bitstream further comprises:
decoding object position parameters; and
decoding the first index of the first label associated with the object based on the object position parameters.

7. The method of claim 1, wherein decoding the message from the bitstream further comprises:
decoding a polygon to indicate a shape and a position of the object in the picture.

8. The method of claim 1, wherein decoding a message from a bitstream further comprises:
decoding a polygon indicating a shape and a position of the object in the picture.

9. The method of claim 8, wherein decoding the polygon indicating the shape and the position of the object in the picture further comprises:
decoding a number of vertices of the polygon; and
decoding a coordinator of each vertex of the polygon.

10. The method of claim 1, wherein decoding a message from a bitstream further comprises:
decoding a depth of the object to indicate a relative position of objects.

11. An apparatus for determining an object in a picture, the apparatus comprising:
a memory figured to store instructions; and
one or more processors configured to execute the instructions to cause the apparatus to perform:
decoding a message from a bitstream comprising:
decoding a first list of labels; and
decoding a first index, to the first list of labels, of a first label associated with the object; and
determining the object based on the message.

12. The apparatus of claim 11, wherein the one or more processors are further configured to execute the instructions to cause the apparatus to perform:
decoding a second index, to the first list of labels, of a second label associated with the object, wherein the second index is different from the first index.

13. The apparatus of claim 11, the one or more processors are further configured to execute the instructions to cause the apparatus to perform:
decoding a second list of labels, wherein the first and second label lists do not include a same label; and
decoding a second index, to the second list of labels, of a second label associated with the object.

14. The apparatus of claim 11, the one or more processors are further configured to execute the instructions to cause the apparatus to perform:
decoding a second list of labels corresponding to labels in the first list of labels, respectively; and
decoding a second index, to the second list of labels, of a second label associated with the object.

15. The apparatus of claim 11, the one or more processors are further configured to execute the instructions to cause the apparatus to perform:
decoding a polygon indicating a shape and a position of the object in the picture.

16. The apparatus of claim 15, the one or more processors are further configured to execute the instructions to cause the apparatus to perform:
decoding a number of vertices of the polygon; and
decoding a coordinator of each vertex of the polygon.

17. The apparatus of claim 11, the one or more processors are further configured to execute the instructions to cause the apparatus to perform:
decoding a depth of the object to indicate a relative position of objects.

18. A non-transitory computer readable medium that stores a set of instructions that is executable by one or more processors of an apparatus to cause the apparatus to initiate a method for determining an object in a picture, the method comprising:
decoding a message from a bitstream comprising:
decoding a first list of labels; and
decoding a first index, to the first list of labels, of a first label associated with the object; and
determining the object based on the message.

19. The non-transitory computer readable medium of claim 18, wherein the set of instructions that is executable by one or more processors of an apparatus to cause the apparatus to further perform:
decoding a second index, to the first list of labels, of a second label associated with the object, wherein the second index is different from the first index.

20. The non-transitory computer readable medium of claim 18, wherein the set of instructions that is executable by one or more processors of an apparatus to cause the apparatus to further perform:
decoding a second list of labels, wherein the first and second label lists do not include a same label; and
decoding a second index, to the second list of labels, of a second label associated with the object.

21. The non-transitory computer readable medium of claim 18, wherein the set of instructions that is executable by one or more processors of an apparatus to cause the apparatus to further perform:
decoding a second list of labels corresponding to labels in the first list of labels, respectively; and
decoding a second index, to the second list of labels, of a second label associated with the object.

22. The non-transitory computer readable medium of claim 18, wherein the set of instructions that is executable by one or more processors of an apparatus to cause the apparatus to further perform:
decoding a polygon indicating a shape and a position of the object in the picture.

23. The non-transitory computer readable medium of claim 22, wherein the set of instructions that is executable by one or more processors of an apparatus to cause the apparatus to further perform:
decoding a number of vertices of the polygon; and
decoding a coordinator of each vertex of the polygon.

24. The non-transitory computer readable medium of claim 18, wherein the set of instructions that is executable by one or more processors of an apparatus to cause the apparatus to further perform:
decoding a depth of the object to indicate a relative position of objects.
